(19) United States
(12) Patent Application Publication
(10) Pub. No.: US 2007/0137981 A1
(43) Pub. Date: Jun. 21, 2007

(54) CONFIGURABLE MODULAR CHAIN-DRIVEN PALLET TRANSFER SYSTEM

(76) Inventor: Russell Kettelson, Chesterfield, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/611,545

(22) Filed: Dec. 15, 2006

Related U.S. Application Data
(60) Provisional application No. 60/751,043, filed on Dec. 16, 2005.

(51) Int. Cl. B65G 47/24

(52) U.S. Cl. 198/411

(57) ABSTRACT

Configurable modular chain pallet transport systems are described. The systems primarily include a roller chain having link pins that are extended out on both sides to enable pucks to be simply pushed on the chain sides, i.e., between or over the pins. The pucks are designed to be slightly taller than the chain link heights (i.e., tall enough to allow long term wear and ensure that nothing but the drive and take-up sprocket's teeth ever touches the steel chain's rollers and links), wherein the chain is sandwiched between the pucks, and also suspended (i.e., centered height-wise) by the pucks. The transport systems also provide simplified pallet redirection operations, or combinations of redirection and reorientation of pallets. With respect to pallet redirection/radial reorientation scenarios, there are four primary equipment set-ups, each being comprised of simple, statically mounted tooling at the angular intersections of the various conveyor modules of the transport systems.

### CROSS-REFERENCE TO RELATED APPLICATION

The instant application claims priority to U.S. Provisional Patent Application Ser. No. 60/751,043, filed Dec. 16, 2005, the entire specification of which is expressly incorporated herein by reference.

### FIELD OF THE INVENTION

The instant invention relates generally to pallet conveyor transport systems, and more particularly to new and improved pallet transport systems, and methods of use therefor, that can be readily and inexpensively configured with modular components to perform a wide range of pallet handling operations, such as but not limited to pallet stopping and releasing, pallet locating, lateral transferring of pallets, radial reorientation of pallets, redirection of pallets, and combinations of these handling operations.

### BACKGROUND OF THE INVENTION

Conventional pallet conveyor transport systems, of both chain and roller types, have been in use for many decades. In order to be useful in most practical environments, such systems must be able to change the orientation of pallets moving along them and also accommodate requirements for various changes of direction in the pallet flow and combinations thereof.

In conventional pallet conveyor transport systems, pallet reorientation, i.e. the radial rotation of a pallet while it is moving along a single directional axis, is a complicated process. For example, when a moving pallet requiring radial reorientation at a subsequent process station leaves the preceding station, it must be re-oriented prior to arriving at the next station. To accomplish this, conventional pallet conveyor transport systems typically require the use of a complicated and time-consuming series of operations.

First, an expensive energy-absorbing pallet stopping device typically stops the moving pallet. This device most commonly incorporates a complicated cylinder/valve mechanism that in turn incorporates at least one or two integral position sensors with related feedback loops. Next, a pallet present sensor signal is typically sent to a pallet elevation device. Next, the pallet is typically lifted off the conveyor system by a second, typically equally expensive, pallet lift device. Then a third device, e.g., an expensive energy absorbing pallet rotator, typically rotates the lifted pallet. This mechanism is usually integrated into the pallet lifting system and typically employs another cylinder/valve mechanism, as well as a motor/reducer subsystem. Finally, the now reoriented pallet is typically lowered back onto the conveyor and allowed to proceed to the next station.

The process of changing the direction of pallet flow, e.g., turning a corner in an assembly line or being shunted onto a subsidiary conveyor of intermediate location, e.g., flowing in a lateral direction, is even more complicated in conveyor systems relying on conventional technology. In these conventional systems, pallet redirection operations require even more specialized non-value added equipment of even higher cost. With respect to conventional systems of the roller conveyor type, the need for expensive additional equipment arises primarily from the fact that the rollers simply roll in a parallel direction on the pallet bottom, thus driving the pallet in a singular linear direction. This straight-line process, while perhaps appropriate for very simple conveyor operations, is not well adapted to the requirements of pallet redirection on more sophisticated lines. By definition, such systems are devoid of any notable contact surface friction dynamic and therefore cannot make use of any lateral skidding effect as a component of redirecting the pallet. In fact, such skidding would be severely detrimental to proper conveyor function and component life.

In most of the conventional systems of the roller chain type, the same considerations apply. Even in the few current chain roller pallet conveyors with traditional chains that can abide heavy chain pull loading, said chains can not fully tolerate such non-parallel skidding, as per their topside non-centralized pallet contact chain attachments, the underlying side-loaded components wear severely because they are not really designed to negotiate the side loads of the skidding phenomenon. Additionally, the combination of these ill-suited topside pallet contact attachments and underlying chain components are far too bulky to effectively minimize the pallet contact pitch diameter around conveyor sprockets and also introduce the counterproductive mechanical action referred to as chain hop when conforming to the round sprocket. The final analysis is that conventional chain configurations can not provide adequate minimal rectangular profile, high strength, all direction loading, non-chain hop, and ideal long life functionality.

For all these reasons, current pallet conveyor systems of all types must employ many subsystems and devices to accomplish pallet reorientation and redirection, and more often than not, much of the additional complexity of almost all system types are devices devoted to accommodating self-inflicted stepped-height interfaces.

In either roller of conventional roller chain conveyors, in one example of a corner, the moving pallet must once again be stopped by an expensive energy absorbing pallet stop. As before, the pallet stop most often relies on a complicated cylinder/valve mechanism that incorporates at least one or two integral position sensors with related feedback loops. Once again, a pallet present sensor signal is actuated. The sending end must not only incorporate all the features identified earlier, but the conveyor must work in conjunction with, an expensive motor-driven power-on transfer device having its own pallet present and pallet clear sensors. The receiving conveyor system that will carry the pallet off in a new direction must have been outfitted at its receiving end with an integrated cylinder/valve driven pallet lift device outfitted with at least two integrated position sensors. In addition, the pallet lift on the receiving conveyor must be operated or controlled so as to ensure that it is in the up position as the pallet approaches. Once the receiving pallet lift is up, the pallet must then be transferred to the receiving pallet lowering device. That pallet lowering device then lowers the pallet onto the receiving conveyor system that carries the pallet off in the new direction. If a direction change other than 90° is needed, then process becomes even more complex, time-consuming and expensive.

Where conventional pallet transport systems are required to perform more difficult pallet redirection operations such as selectively off-loading or on-loading a pallet from or to the main conveyor from or to a subsidiary conveyor abutting the main line at 90°, e.g., often referred to as intersection transitions, the current art is even more costly and expensive. In conventional systems, the specialized equipment investment is typically as follows. The moving pallet must first be stopped by an expensive cylinder/valve operated energy absorbing pallet stop device which itself must be outfitted with at least one or two integral position sensors. This operation must actuate a pallet present sensor. The pallet present signal must then trigger a pallet lift device that, in turn, must then elevate the stopped pallet off the primary conveyor and precisely lift it so as to align it with the receiving height of the abutting secondary conveyor. The protocol is further complicated by the need for the pallet lifter to integrate, or operate in precise conjunction with, an expensive chain or roller type motor driven power-on/power-off device that rolls the elevated pallet to or from the subsidiary conveyor system. This power on/power off transfer device, in turn must be outfitted with a fully integrated pallet clear/pallet present sensor system. Even with all this additional complexity, the subsidiary conveyor line must be at a different level than the main line. These resultant staggered conveyor heights in turn cause additional elevation device related expenses further down the line in complex conveyor systems.

Another strategy commonly used in the current art to achieve a change of direction of pallet flow is the use of a curved corner configuration. In conventional systems using this approach, the moving pallet must often be metered through the curved corner, in many cases employing pallet stop devices similar to those described above as well as two or more pallet present sensors. Then, the front end of the lead-in conveyor and the rear end of the 90° oriented outgoing conveyor must both interface with an expensive and floor space wasting curved section of conveyor having its own separate motorized drive unit or incorporating mechanical drive components to be slave-driven by either of the interfacing conveyors. Furthermore, such systems must rely on one ore more integrated corner clear of pallet sensors.

As can be seen from the foregoing, conventional pallet conveyor systems are significantly deficient in that they are ill-suited to accommodate pallet reorientation or redirection in a dynamic fashion. In order to perform such operations, current pallet conveyor systems must be substantially over-engineered to include and integrate expensive and relatively complicated lift, transfer and sensor add-on systems to further include many additional companion pallet stop and on-deck stop devices. All these additional devices and systems cause higher capital costs, increased engineering costs, greater installation and debugging problems, increased likelihood of mechanical failure, decreased through-put; increased controls and controls programming costs, longer line-down periods, and significantly greater long-term maintenance costs while yielding no value to the process.

Another problem with conventional systems occurs during pallet redirection operations. The necessity of lifting the pallet off the sending line and ultimately lowering it onto the adjacent receiving line makes it virtually impossible to cost-effectively run the two lines at the same distance from the floor.

A related problem is the dependency of conventional conveyor applications on a myriad of forms of pallet-lifting mechanisms. Not only are these devices expensive, but also they greatly slow throughput because the pallets must be brought to a virtual stop and stabilized before the lifting operation can begin.

A further problem with conventional conveyor systems has to do with the wear and tear that such systems inflict on the pallets themselves. In current art, the steel plates which make up the bottom of the pallets must be made of expensive heat-treated steel in order to be hard enough to withstand the contact work abuse to which they are subjected by heavy impact contact with the rollers of conventional roller conveyors or the chain rollers or chain attachments of conventional chain conveyors.

Yet another problem of current conveyor transport systems (e.g., both roller and roller chain types) is that the pallet load (i.e., weight) of all pallets throughout a given transport system remain on the rollers or roller chain of the continuously running conveyors (i.e., other than at the required locations of the non-value added elevation and lowering devices of the current art). This in turn unavoidably results in the constant, never-ending peak load wear (e.g., through frictional contact and thermal abuse) of roller or roller chain components and all associated drive components throughout the transport system.

Accordingly, there exists a need for new and improved pallet transport systems, such as but not limited to configurable modular chain-driven pallet transport systems, that overcome at least one of the aforementioned disadvantages of conventional pallet transport systems, and in so doing provides a new and useful system and method of use therefor that can readily and inexpensively facilitate the pallet transfer, reorientation and redirection requirements of pallet transport system end-users in a very wide range of industrial assembly, warehousing and/or material handling applications.

### SUMMARY OF THE INVENTION

In view of the foregoing disadvantages inherent in the known types of pallet transport systems now present in the prior art, the present invention provides new and improved pallet transport systems, and methods of use therefor, that can be readily and inexpensively configured with modular components to perform a wide range of pallet handling operations, such as but not limited to pallet stopping and releasing, pallet locating, lateral transferring of pallets, radial reorientation of pallets, redirection of pallets, and combinations of these handling operations.

More specifically, the present invention provides powered conveyors for moving pallets, and more particularly new and improved modular chain type pallet conveyance transport systems that incorporate and embody new and innovative components that are also very low cost, straight forward and predominantly static/motionless. These innovations include some contributing to the total elimination of, and others contributing to greatly minimize the need for the myriad of present day component complexity continually employed to facilitate the transfer functions of pallet radial reorientation, pallet redirection, pallet lateral transfer, pallet elevating and lowering, and pallet stopping and registering.

The present invention also provides dynamic and flexible components that provide two major benefits. The first benefit eliminates essentially all possible items of non-value added pallet handling equipment and technology found in conventional conveyor systems, thus greatly minimizing both the initial capital costs and life cycle maintenance costs. The second benefit enables the utilization of a chain type conveyor module approach, having all the advantages of roller conveyors, but with none of their disadvantages, thus greatly minimizing both initial capital costs and life cycle maintenance costs.

One of the features of this invention is to greatly increase the capability, and thus flexibility, of the most basic conveyor chassis design possible, e.g., a chain conveyor with a radically innovative chain design approach. By way of a non-limiting example, a chain conveyor utilizes a roller chain which is essentially standard, except that its link pins are extended out on both sides to enable pucks (e.g., of appropriate material formulation, shape and arrangement per duty requirements) to be simply pushed on the chain sides, between or over the pins, wherein the pucks themselves are slightly taller than the chain link heights (e.g., tall enough to allow long term wear and ensure that nothing but the drive and take-up sprockets teeth ever touches the actual steel chain's rollers and links), such that the chain itself is sandwiched (i.e., protected) between the pucks, and also, suspended (e.g., centered height-wise) by the pucks. The end-view of the chain then becomes a rectangular cross-section, which is able to sustain both compressive loading and sliding friction abuse of any vector dynamic applied on all four sides and, because the roller chain itself is essentially standard, it provides the strongest chain pull loading possible. In terms of the over-all chain pull loading induced by the compression loading and friction coefficient loading of the pallets, all chain pull resultant loading is essentially perfectly central to the chain pins and sprocket pitch diameter. Thus, both the top and bottom surfaces of the pucks are uniformly loaded with effectively no moment loading at all.

Another feature of this invention is its universally adaptive and flexible conveyor chassis (e.g., modules) wherein the illustrative construction is a dual beam conveyor chassis. An illustrative module where each of the rectangular chain beams are made of the same symmetrical hollow aluminum extrusion with “t” slots on the bottom and both sides and with a topside chain channel and optional blue steel channel bed rail, and further, each beam having pinch slots on both sides of the chain channel for insertion of a blue steel pallet guide rail in the appropriate outside pinch slot of each of the two spread beams wherein an optional pinch shim may be utilized to secure the blue steel pallet guide rail. Both beams of a given conveyor module can be top slotted at each end to facilitate both the drop-in drive sprocket's and the take-up sprocket's removal, and a full width slot (e.g., matching the inner walls of the extruded chain beam) for the chain's clearance as they descend and ascend at the respective drop-in drive and take-up ends (e.g., to recirculate) at the bottom inside of the extruded chain beam. Finally, on the inside front-end sidewall of each chain beam can be a drive-shaft hole to facilitate the stub drive shafts of the drop-in drive of this invention, and, on the inside rear sidewall of each beam will be a take-up slot to facilitate the clamp screw of the take-up unit.

Still another feature of this invention is the four basic conveyor module configurations needed to facilitate all possible system requirements and conditions. These four modules are, without limitation, the uniform length conveyor module, the uniform length conveyor module with flush adjustment feature at the drive end, the staggered length conveyor module, and the staggered length conveyor module with flush adjustment feature at the drive end. The intended purpose for the flush adjustment feature is to have a short built-in portion of the conveyor vertically pivotally adjustable to facilitate uneven chain puck wear over time at angular modular interfaces greater than 45°, (e.g., to adjust the interfacing chain systems of the two involved modules back to a pseudo-flush relationship, thus allowing the rest of the conveyor module to be locked down firmly to the floor, i.e. never to be moved, thus never moving relative to work stations mechanically tied to the conveyors. Conveyor module interfaces that are in-line, and those with an interface bend up to 45°, will function fine without the need of the flush adjustment feature because of the directness of interface approach as the pallets transfer off the front end of one module and onto the other because their two chain systems work in cooperation. Those modules with interface bends greater than 45° should have the flush adjustment feature, and those nearing 60°, 90° and beyond must have the flush adjustment feature because of the increasing trend toward perpendicularity of pallet-to-chain transitional engagement, wherein the two interfacing chain systems, if not adjusted to the pseudo-flush relationship (i.e., parameter zone), will not function properly in all cases where the incoming module's chains, over time, either wear less or more than the outgoing modules chains, thus either not allowing the pallet to effectively frictionally engage the outgoing conveyor modules chains, or, having fallen too low to engage (i.e., climb onto) the outgoing modules chains. Also, it should be noted that per the illustrative pivot methodology of this invention, per the pivot spine, the extrusion gap, the jack features, the clearance gap between the torsion bracket of the flush adjustment feature, that the spread chain beams of the flush adjustment feature are flexibly pliable, in that it can individually be purposefully vertically distorted about the chain beam pivot spines to give greater versatility for flush adjustments to the imperfect precision/location of the outgoing conveyor module's chain beams. Here, pseudo flush relationship simply means that the incoming module's chains at the module's drive sprockets must be a very small amount lower than the outgoing module's chains. The four innovative conveyor modules of this invention will facilitate conveyor system designs of any configuration, e.g., all clockwise (CW) or counter-clockwise (CCW) 90° pallet rotations of this invention, all CW or CCW 0° to 120° corner intersection redirections of this invention, single or double lateral power on/off transfers of this invention, the pallet enablers of this invention which totally control, locate and meter (e.g., stop and release) pallets throughout a given system, and the pallet product carriers of this invention.

By way of a non-limiting example, it is the combination of one or more of these chain and conveyor module innovations of this invention, that enables the pallet handling dynamics, that further enable the remarkable elimination of the many non-value added mechanical components, functional complexities, controls components and programming content, and equipment life cycle maintenance previously identified.

Yet another feature of this invention is to greatly improve on the simplicity, unobtrusiveness, and easy access for maintenance of the conveyor module drives, over those of the prior art. The drop-in motor/reducer drives of this invention can be located at the front of each conveyor module, between the chain beams, suspended per its output shaft, supported by bearings (e.g., which are “T” bolted to the chain beams), and assembled to the stub drive shafts by the four screws of the two split clamp collars. Further, it should be noted that the motor reducer can be rotationally secured by the torsion bracket and four jam screws by entrapment only as there is a clearance gap between the motor reducer bottom face and the torsion bracket and that the four jam screws can merely protrude into aligned clearance holes in the torsion bracket such that the motor reducer with its output shaft can simply lift out once the four split clamp collar screws are removed, thus the phrase “drop-in drive.” Also, it should be noted that there can be a control dowel that goes through both interlocked ends of the output shaft and the interlocked end of each stub drive shaft. All motor/reducers with their output shaft can be lifted straight out the top (i.e., absolutely unobstructed everywhere a drive exists). Then, if desired, the two stub shafts that drive the two sprockets can remain totally accessible to be laterally pulled out of each sprocket's shaped hole (e.g., simple square, hex, spline, and/or the like) and each beam's double “T” bolted with a nut-flange bearing. A motor/reducer of a drop-in drive could easily be replaced in 2 to 3 minutes.

Still yet another feature of this invention is to greatly improve on the simplicity, unobtrusiveness, and easy access for maintenance/adjustment of the conveyor module's chain take-up unit, over those of the prior art. The take-up of this invention can be designed such that it clamps itself to the inside wall of the conveyor module chain beam with the same single bolt that is used for its adjustment. The bolt can extend through an external clamp hub, through the horizontal slot of the inner wall of chain beam, through the internal clamp hub, and tread into the flanged bearing boss, which goes into the bearing, which supports the take-up sprocket. Additionally, a leverage hub can be clamped to the same inside wall of the chain beam, below and near the external clamp hub (e.g., by way of a “T” nut and a screw). This leverage hub can be used as follows when tightening a chain beam's chain: Loosen the bolt, then insert anything (e.g., steel bar, long wrench, and/or the like) between the external clamp hub and the leverage hub, pull back to the desired tension, and then hold that tension as you retighten the bolt.

Toward this purpose, some of the innovative components of this invention include, without limitation, configurable modular chain conveyors, two models of uniform chain beam lengths (e.g., one of which has a drive end interface flush adjustment feature) and two models of staggered chain beam lengths at given conveyor module rears (e.g., one of which has a drive end interface flush adjustment feature) to facilitate approximately >45° to approximately 120° redirection corner interfaces (e.g., with respect to the front drive end of a given preceding conveyor module) or <45° bend interfaces (e.g., with respect to the front drive end of a given preceding conveyor module, i.e., not needing a flush adjustment feature), a new conveyor chain design with puck attachments to facilitate the versatile pallet loading and frictional drive dynamics required throughout the system, a new conveyor mounted claw and pallet mounted corner post engagement design methodology to facilitate continuous motion CW or CCW 90° and 180° radial reorientation of pallets in straight transfer, and a family of angular conveyor mounted corner claws to facilitate continuous motion pallet redirection and also pallet radial reorientation (e.g., up to approximately 120° CW or CCW pallet redirection corners), new selective tooling groups (e.g., sometimes with, sometimes without claws) to facilitate the conveyor's CW or CCW redirection corners wherein pallets can also end up with a radial reorientation of 0° or 90° or 180° CW or CCW with respect to flow.

Further innovations of this invention are a dual direction lateral transfer (power on/off) unit that, having no need for an elevating/lowering mechanism contributes to the elimination of multiple conveyor module heights found in conventional systems, a pallet enabler, which essentially replaces the single pallet workstation stops and multiple pallet accumulation on-deck stops of the prior art, but does so with major advantages. The pallet enabler functions such that it can work in cooperation with, and harness, the inertial mass of a given pallet (i.e., not the drive friction of the conveyor) to enable the moving pallet to lift itself off the conveyor chain, with the aid of two additional conveyor mounted rollers, and, self-stop in a precision X and Z position (and at workstations where desired, with the further addition of simplistic conveyor mounted jack bars, precision Y positioning is also attained), thus totally eliminating the need for the high cost and space consuming pallet lift-and-locate mechanism of the prior art. The pallet enabler of this invention functions both as the pallet stop and the now totally deleted lift-and-locate mechanism. Further, because pallet enablers are also utilized at as many pallet on-deck positions as desired and spaced so that pallets do not contact each other, there is no need for the pallet bumpers of the prior art. Also, because pallets are always off the conveyor chain when in their stopped positions, there is no pallet induced chain drive backpressure, nor is there any pallet load applied to the chains in said stopped positions. The pallet enabler of this invention improves chain life anywhere from 400% to 500% because the maximum time pallets spend on the chains is approximately 20% (e.g., in a non-synchronous system of the prior art having two to three on-deck pallets at workstations, pallets spend approximately 80% of their time on the chains, even more if some of the workstations don't lift and locate the pallet). This invention further consists of an innovative conveyor module drop-in drive unit, and a unique chain tightening methodology based on an integrated single screw fastener chain and sprocket take-up device.

With respect to palletized chain conveyors versus roller conveyors, an important point is the big benefit of the combined features of this invention in that they bring the chain type conveyor back into favor over the roller conveyors of present day use. The innovative features of this conveyor system invention, in addition to deleting almost all non-value added mechanisms, processes and controls of all conveyor system types, also eliminate the two past big negatives of stopped pallets on chain conveyors (i.e., individual and accumulated pallets): (1) harmful backpressure; and (2) short chain life. Generally stated, basic chain conveyors are much lower in cost than basic roller type conveyors. This fact, in combination with the innovative advancements, the deletion of across-the-board non-value added equipment, and the deletion of the chain conveyor negatives of the past, puts this chain type invention in a most favorable light. In a conveyor system cost scenario, the end user should expect to purchase a system of this invention's general make-up for about half the cost of previous systems of any make-up, and spend far less than half the cost to maintain such a system over its lifetime of use.

The features of this invention reduce the equipment (e.g., motion devises/controls) requirements to such an absolute and unprecedented minimum that there is essentially nothing between the chain strand beams of the conveyor throughout a given system other than the conveyor module drives (e.g., electric as standard, but not limited thereto), pallet enablers at selected station locations (e.g., electric as standard, but not limited thereto) or lateral transfer units where desired (e.g., electric as standard, but not limited thereto). In other words, the ideal system of this invention favors electric over pneumatic and/or hydraulic devices and their cost intrusive piping, wiring and controls content requirements.

A further feature of this invention is to greatly reduce the cost of reorienting pallets (i.e., rotating them) in conveyor transport systems (by 90° or 180°) by eliminating the need for complex non-value added subsystems to accomplish the task. In the improved conveyor transport system of the present invention, all the previously described conventional stopping, lifting, rotating, sensing and control equipment needed for radial pallet reorientation is replaced by the pallet rotate system of this invention. The pallet rotate system is simply comprised of a very low cost pallet engagement claw and a pallet sweep guard. The pallet engagement claw is static and is mounted on a selected side of a given conveyor module, depending on the desired direction of pallet rotation of a straight moving pallet. The system pallets themselves are each provided with four topside irregular shaped pallet posts of a two-tier construction, one located at each of the pallet corners. When the moving pallet reaches the engagement claw, the pallet's left or right irregular shaped lead post engages the left side or right side conveyor mounted engagement claw (e.g., mounting depending on the desired direction of rotation). This engagement, which restricts the claw side of the pallet from forward progress, in conjunction with the continuing movement of the conveyor chains, initiates a dynamic moment dictated friction driven radial rotation about the coaxially aligned engagement claw and irregularly shaped pallet post (i.e., per the pallet's loading on the conveyor's unrestricted opposite side/chain) until 90° of rotation has occurred. During this pallet reorientation/rotate process, the pallet remains in continual motion (having never actually been stopped in its transfer) wherein the pallet's motion simply transitioned from straight to a frictionally skidding radial sweep and then back to straight as it exits the engagement claw. At this point, the irregular shaped pallet post's profile is slightly smaller than the engagement claw's built-in pass through opening, enabling the no longer captive and now reoriented pallet to continue its transfer in the same direction. If a 180° pallet rotation is needed, two pallet engagement claws are simply mounted in immediate series.

An additional feature of this invention is to greatly simplify and reduce the cost of pallet redirection operations, or combinations of redirection and reorientation of pallets exiting corners. In the case of such operations, all the complex equipment needed to redirect the direction of flow of a pallet is similarly replaced in the instant invention by a simple, low cost conveyor mounted corner claw located (e.g., mounted) at the inside corner of the two involved interfacing conveyors (e.g., having chains moving linearly in different directions). In the prototypical case of a 90° CCW right-angle turn, where a pallet is also to be reoriented 90° CCW (e.g., with respect to its radial orientation to pallet flow), for example, the sequence is similar to that used in the pallet radial reorientation procedure above. The static corner claw simply engages the respective lead pallet post. The pallet then automatically starts its dynamic moment dictated friction driven 90° CCW rotation about the coaxially aligned corner claw and irregularly shaped pallet post. The conveyor configuration is such that the lead or drive end of the merging conveyor interfaces with the staggered chain beam length rear end of the adjacent receiving conveyor at a right angle. Here, in continuous motion, the claw and post engagement, in conjunction with the continuing movement of each of the two conveyor's two chains, initiates and sustains a dynamic moment dictated friction driven radial rotation about the coaxially aligned corner claw and irregularly shaped pallet post (e.g., per the pallet's loading on both of the conveyor's unrestricted opposite side chains) until 180° of CCW rotation has occurred (i.e., in space). During this pallet redirection and reorientation/rotation process, the pallet remains in continual motion (e.g., having never actually been stopped in its transfer) wherein the pallet's motion simply transitioned from straight to a frictionally skidding radial sweep and then back to straight as it exits the corner claw. At that point, the irregular shaped pallet post's profile is slightly smaller than the claw's built-in pass through opening, enabling the no longer captive pallet to continue its transfer in the new direction and new radial orientation. Thus, while the pallet direction changes by 90° CCW relative to the centerlines of the two conveyor segments that are running at right angles to each other, the pallet itself is also rotationally reoriented 90° CCW with respect to its centerline of conveyor flow.

Another example of one of the features of this invention is another type of prototypical 90° redirection corner where no corner claw is used to result in both a 90° CCW redirection and a 90° CW radial reorientation of the pallet. In this case, the pallet enters a corner straight, and, in a continuous motion exits the corner laterally (i.e., sideways) straight, however, here, conveyor mounted pallet underside support rollers will be needed to support the pallet's weight distribution because, after getting to the end of the straight incoming transfer (i.e., flush against the outside pallet guide rail of the outgoing conveyor), the pallet immediately starts moving laterally (i.e., sideways) straight out onto the outgoing conveyor of perpendicular position, as it transitions off the incoming conveyor's outside chain, and onto the support rollers and the outside chain of the outgoing conveyor. Then, the pallet moves back to a balanced footing on both chains of the outgoing conveyor. In this model of a redirection corner, either the pallet or the outgoing conveyor's outside guide rail will have rollers to minimize outgoing friction resistance, as the friction dynamics of the two perpendicularly opposed conveyor chain systems naturally per the laws of physics (e.g., as channeled by the support rollers and guide rail tooling positions), frictionally power the pallet through the redirection corner in a non-stop motion.

Other simple repositioning possibilities of this invention's methodology allow for a myriad of factory floor adjustments and variations and respectively a myriad of outcomes. It must also be understood that anything of CW direction, orientation, or motion can also be of CCW direction, orientation, or motion.

Examples of the many features of this invention with respect to tooling order and combinations for various exiting pallet orientations of a prototypical CCW (e.g., left turn) redirection corner are as follows: The use of a left side in-transit type pallet engagement claw just a few inches prior to (e.g., not at) the corner, and pallet underside support rollers and positioned outgoing conveyor pallet guide rail, will also result in an exiting pallet radial reorientation of 0°. The use of no pallet engagement claw, and pallet underside support rollers and positioned outgoing conveyor pallet guide rail will also result in an exiting pallet radial reorientation of 90° CW. The use of a left side pallet engagement corner claw alone will also result in an exiting pallet radial reorientation of 90° CCW. If, when exiting a redirection corner, a total pallet radial reorientation of 180° CW or CCW is desired, an additional in-transit type claw must be appropriately utilized in series at either the entrance or exit of the corner and on the left or right side as appropriate.

Where lateral transfer devices are necessary, a further feature of this invention is to simplify such transfer operations and reduce the need for subsidiary systems to a minimum. As briefly noted above, transport function of this invention at an intersection requiring one is a simple power-on/off chain drive unit that merely turns on in the desired lateral direction to transfer a given pallet onto or off of an adjacent abutting conveyor, i.e., there are no motion/device requirements beyond that of the power-on/power-off unit's moving chain which laterally transfers the pallet to or from an incoming or outgoing adjacent conveyor of perpendicular orientation and common height. Nor is there a need for non-value added pallet lift equipment at the perpendicular conveyor intersections of lateral transfer along a given conveyor length. In fact, no pallet lift mechanisms are ever required anywhere in the pallet transport system embodied in this invention. The power on/off unit of this invention also uses the same puck embodied chain as the conveyors of this invention.

A still further feature of this invention is to reduce capital and maintenance costs by creating a conveyor environment in which lower cost or lighter pallets made of non-hardened steel and other, softer but lighter materials such as but not limited to aluminum, can be regularly used. In the improved conveyor transport system of this invention, the steel pallet plates can remain soft, negating the need for expensive steels hardened by heat treatment or other methods. Further, the pallet plate material can also be soft aluminum. This situation is made possible by the non-metallic formulation of the innovative conveyor chain pucks integrated into the invention. By way of a non-limiting example, the pucks can be comprised of a low cost material, such as but not limited to ultra high molecular weight polyethylene (UHMWPE) and/or as many material formulations that can be applied to facilitate optimum loading vs. durable life along with several adaptive chain puck arrangements. These relatively soft pucks do not wear the soft steel or aluminum pallet plates as the pallet plate bottoms slide and skid against them during the various pallet transfer functions that occur throughout the system. Simply put, the gravitational friction dynamic between pallet and puck will not result in wear on the pallet that in any way approaches the level of wear engendered by the metal-on-metal contact in conventional systems based on the current art.

A yet still further feature of this invention is to provide for the easy construction of even complex pallet transport systems without any variations in elevation whatsoever. Because there are no pallet lift or other pop-up devices anywhere in the system, this invention maintains the same pallet/conveyor height throughout the system no matter how complex the conveyor system configuration.

In accordance with a first embodiment of the present invention, a pallet transport system is presented, comprising: (1) at least one conveyor module; and (2) at least one pallet member selectively operable to be disposed on top of and transported by the at least one conveyor module in a first orientation or direction, wherein the at least one conveyor module is selectively operable to cause the at least one pallet member to travel in a second orientation or direction, wherein the at least one conveyor module is selectively operable to cause the at least one pallet member to travel in a third orientation or direction, wherein the at least one pallet member includes at least one post member extending from a peripheral portion of the at least one pallet member, wherein the at least one conveyor module includes at least one engagement member selectively operable to engage the post member, wherein when the at least one engagement member selectively engages the at least one post member, the at least one conveyor module is selectively operable to cause the at least one pallet member to be transported in the second orientation or direction, wherein when the at least one engagement member selectively disengages from the at least one post member, the at least one conveyor module is selectively operable to cause the at least one pallet member to be transported in the third orientation or direction.

In accordance with one aspect of this embodiment, the at least one conveyor module includes a chain system, wherein the chain system includes a plurality of cooperating link pin members and roller members, wherein a first puck member is disposed on at least one of the link pin members. The first puck member includes an area defining a first through bore, wherein a first end portion of the link pin member is selectively operable to be received in the first through bore. The first puck member has a substantially rectangular configuration and/or a beveled surface portion. A second puck member includes an area defining a second through bore, wherein a second end portion of the link pin member is selectively operable to be received in the second through bore, wherein when the first and second ends of the link pin member are received in the first and second through bores, the chain system is substantially enveloped between the first and second puck members.

In accordance with another aspect of this embodiment, the at least one conveyor module includes a chain system, wherein the chain system includes a plurality of cooperating link pin members and roller members, wherein a first puck member is disposed in between two adjacent link pin members. The first puck member has a substantially rectangular configuration and/or beveled surface portion. The first puck member includes a first groove portion formed on at least one surface portion thereof, wherein a first link pin member is selectively operable to be at least partially received in the first groove portion. A second puck member includes a second groove portion formed on at least one surface thereof, wherein a second link pin member is selectively operable to be at least partially received in the second groove portion, wherein when the first and second link pin members are at least partially received in the first and second groove portions, the chain system is substantially enveloped between the first and second puck members.

In accordance with still another aspect of this embodiment, a flush adjustment system is operably associated with the chain system, wherein the flush adjustment system is selectively operable to vertically pivotally adjust at least a portion of the chain system.

In accordance with yet another aspect of this embodiment, the chain system comprises a dual beam system including a first chain member having a first length and a second chain member having a second length, wherein the first length is not equal to the second length.

In accordance with still yet another aspect of this embodiment, a motorized drive system is operably associated with the chain system, wherein the motorized drive system is selectively operable to cause locomotion of the chain system.

In accordance with an additional aspect of this embodiment, a plurality of post members and engagement members are provided.

In accordance with a further aspect of this embodiment, the second orientation or direction comprises a radially sweeping motion by the pallet member.

In accordance with a still further aspect of this embodiment, the first orientation or direction and the third orientation or direction are dissimilar.

In accordance with a yet further aspect of this embodiment, the at least one conveyor module is selectively operable to rotate the at least one pallet member in a clockwise or counterclockwise direction.

In accordance with a still yet further aspect of this embodiment, the at least one conveyor module includes a support roller system for supporting the at least one pallet member as the at least one pallet member attempts to travel onto another conveyor module.

In accordance with an additional aspect of this embodiment, a pallet enabler system is operably associated with the at least one conveyor module, wherein the pallet enabler system is selectively operable to disengage the at least one pallet member from the at least one conveyor module so as to cause the locomotion of the at least one pallet member to cease.

In accordance with a further additional aspect of this embodiment, the at least one conveyor module includes a chain system, wherein the chain system includes a plurality of cooperating link pin members and roller members, and further comprises a pass through lateral transfer system operatively associated with the chain system for transporting the at least one pallet member in a direction angled with respect to the chain system. The pass through lateral transfer system includes a second chain system, wherein the second chain system is angled with respect to the chain system. The second chain system includes a third puck member, wherein the second chain system includes an area free of any of the third puck members, wherein the third puck member permits the angled transportation of the at least one pallet member, wherein the area free of any of the third puck members permits the transportation of the at least one pallet member along the chain system.

In accordance with a first alternative embodiment of the present invention, a pallet transport system is provided, comprising: (1) a first conveyor module; (2) a second conveyor module operatively associated with the first conveyor module; and (3) at least one pallet member selectively operable to be disposed on top of and transported by the first conveyor modules in a first orientation or direction, wherein the at least one pallet member includes at least one post member extending from a peripheral portion of the at least one pallet member, wherein the first conveyor module includes at least one engagement member selectively operable to engage the at least one post member, wherein when the at least one engagement member selectively engages the at least one post member, the at least one conveyor module is selectively operable to cause the at least one pallet member to be transported in a second orientation or direction, wherein when the at least one engagement member selectively disengages from the at least one post member, the first conveyor module is selectively operable to cause the at least one pallet member to be disposed on top of and transported by the second conveyor module in a third orientation or direction.

In accordance with another aspect of this embodiment, either the first or second conveyor modules includes a chain system, wherein the chain system includes a plurality of cooperating link pin members and roller members, wherein a first puck member is disposed on at least one of the link pin members. The first puck member includes an area defining a first through bore, wherein a first end portion of the link pin member is selectively operable to be received in the first through bore. The first puck member has a substantially rectangular configuration and/or beveled surface portion. A second puck member includes an area defining a second through bore, wherein a second end portion of the link pin member is selectively operable to be received in the second through bore, wherein when the first and second ends of the link pin member are received in the first and second through bores, the chain system is substantially enveloped between the first and second puck members.

In accordance with still another aspect of this embodiment, either of the first or second conveyor modules includes a chain system, wherein the chain system includes a plurality of cooperating link pin members and roller members, wherein a first puck member is disposed in between two adjacent link pin members. The first puck member has a substantially rectangular configuration and/or beveled surface portion. The first puck member includes a first groove portion formed on at least one surface portion thereof, wherein a first link pin member is selectively operable to be at least partially received in the first groove portion. A second puck member includes a second groove portion formed on at least one surface thereof, wherein a second link pin member is selectively operable to be at least partially received in the second groove portion, wherein when the first and second link pin members are at least partially received in the first and second groove portions, the chain system is substantially enveloped between the first and second puck members.

In accordance with yet another aspect of this embodiment, a flush adjustment system is operably associated with the chain system, wherein the flush adjustment system is selectively operable to vertically pivotally adjust at least a portion of the chain system.

In accordance with still yet another aspect of this embodiment, the chain system comprises a dual beam system including a first chain member having a first length and a second chain member having a second length, wherein the first length is not equal to the second length.

In accordance with a further aspect of this embodiment, a motorized drive system is operably associated with the chain system, wherein the motorized drive system is selectively operable to cause locomotion of the chain system.

In accordance with a still further aspect of this embodiment, a plurality of post members and engagement members are provided.

In accordance with a yet further aspect of this embodiment, the second orientation or direction comprises a radially sweeping motion by the pallet member. The first orientation or direction and the third orientation or direction are dissimilar.

In accordance with a still yet further aspect of this embodiment, either of the first or second conveyor modules are selectively operable to rotate the at least one pallet member in a clockwise or counterclockwise direction.

In accordance with an additional aspect of this embodiment, either of the first or second conveyor modules include a support roller system for supporting the at least one pallet member as the at least one pallet member attempts to travel on either the first or second conveyor modules.

In accordance with a still additional aspect of this embodiment, a pallet enabler system is operably associated with either of the first or second conveyor modules, wherein the pallet enabler system is selectively operable to disengage the at least one pallet member from either the first or second conveyor modules so as to cause the locomotion of the at least one pallet member to cease.

In accordance with a further additional aspect of this embodiment, either the first or second conveyor modules include a chain system, wherein the chain system includes a plurality of cooperating link pin members and roller members, and further comprises a pass through lateral transfer system operatively associated with the chain system for transporting the at least one pallet member in a direction angled with respect to the chain system. The pass through lateral transfer system includes a second chain system, wherein the second chain system is angled with respect to the chain system. The second chain system includes a third puck member, wherein the second chain system includes an area free of any of the third puck members, wherein the third puck member permits the angled transportation of the at least one pallet member, wherein the area free of any of the third puck members permits the transportation of the at least one pallet member along the chain system.

In accordance with a second alternative embodiment of the present invention, a pallet transport system is provided, comprising: (1) a first conveyor module; (2) a second conveyor module operatively associated with the first conveyor module; (3) a third conveyor module operatively associated with the second conveyor module; (4) a fourth conveyor module operatively associated with the third conveyor module; and (5) at least one pallet member selectively operable to be disposed on top of and transported by the first conveyor module in a first orientation or direction, wherein the at least one pallet member includes at least one post member extending from a peripheral portion of the at least one pallet member, wherein the first conveyor module includes at least one engagement member selectively operable to engage the at least one post member, wherein when the at least one engagement member selectively engages the at least one post member, the at least one conveyor module is selectively operable to cause the at least one pallet member to be transported in a second orientation or direction, wherein when the at least one engagement member selectively disengages from the at least one post member, the first conveyor module is selectively operable to cause the at least one pallet member to be disposed on top of and transported by any of the second, third or fourth conveyor modules in a third orientation or direction.

In accordance with an aspect of this embodiment, any of the conveyor modules includes a chain system, wherein the chain system includes a plurality of cooperating link pin members and roller members, wherein a first puck member is disposed on at least one of the link pin members. The first puck member includes an area defining a first through bore, wherein a first end portion of the link pin member is selectively operable to be received in the first through bore. The first puck member has a substantially rectangular configuration and/or a beveled surface portion. A second puck member includes an area defining a second through bore, wherein a second end portion of the link pin member is selectively operable to be received in the second through bore, wherein when the first and second ends of the link pin member are received in the first and second through bores, the chain system is substantially enveloped between the first and second puck members.

In accordance with another aspect of this embodiment, any of the conveyor modules include a chain system, wherein the chain system includes a plurality of cooperating link pin members and roller members, wherein a first puck member is disposed in between two adjacent link pin members. The first puck member has a substantially rectangular configuration and/or a beveled surface portion. The first puck member includes a first groove portion formed on at least one surface portion thereof, wherein a first link pin member is selectively operable to be at least partially received in the first groove portion. A second puck member includes a second groove portion formed on at least one surface thereof, wherein a second link pin member is selectively operable to be at least partially received in the second groove portion, wherein when the first and second link pin members are at least partially received in the first and second groove portions, the chain system is substantially enveloped between the first and second puck members.

In accordance with still another aspect of this embodiment, a flush adjustment system is operably associated with the chain system, wherein the flush adjustment system is selectively operable to vertically pivotally adjust at least a portion of the chain system.

In accordance with yet another aspect of this embodiment, the chain system comprises a dual beam system including a first chain member having a first length and a second chain member having a second length, wherein the first length is not equal to the second length.

In accordance with still yet another aspect of this embodiment, a motorized drive system is operably associated with the chain system, wherein the motorized drive system is selectively operable to cause locomotion of the chain system.

In accordance with a further aspect of this embodiment, a plurality of post members and engagement members are provided.

In accordance with a still further aspect of this embodiment, the second orientation or direction comprises a radially sweeping motion by the pallet member. The first orientation or direction and the third orientation or direction are dissimilar.

In accordance with a yet further aspect of this embodiment, any of the conveyor modules are selectively operable to rotate the at least one pallet member in a clockwise or counterclockwise direction.

In accordance with an additional aspect of this embodiment, any of the conveyor modules include a support roller system for supporting the at least one pallet member as the at least one pallet member attempts to travel on any of the conveyor modules.

In accordance with a still additional aspect of this embodiment, a pallet enabler system is operably associated with any of the conveyor modules, wherein the pallet enabler system is selectively operable to disengage the at least one pallet member from any of the conveyor modules so as to cause the locomotion of the at least one pallet member to cease.

In accordance with a further additional aspect of this embodiment, any of the first, second, third or fourth conveyor modules include a chain system, wherein the chain system includes a plurality of cooperating link pin members and roller members, and further comprises a pass through lateral transfer system operatively associated with the chain system for transporting the at least one pallet member in a direction angled with respect to the chain system. The pass through lateral transfer system includes a second chain system, wherein the second chain system is angled with respect to the chain system. The second chain system includes a third puck member, wherein the second chain system includes an area free of any of the third puck members, wherein the third puck member permits the angled transportation of the at least one pallet member, wherein the area free of any of the third puck members permits the transportation of the at least one pallet member along the chain system.

In accordance with a third alternative embodiment of the present invention, a pallet transport system is provided, comprising: (1) a first conveyor module; (2) a second conveyor module operably associated with the first conveyor module; and (3) at least one pallet member selectively operable to be disposed on top of and transported by either of the first or second conveyor modules, wherein the first conveyor module is selectively operable to cause the at least one pallet member to travel in a first orientation or direction, wherein the second conveyor module is selectively operable to cause the at least one pallet member to travel in a second orientation or direction.

In accordance with an aspect of this embodiment, the at least one pallet member includes at least one post member extending from a peripheral portion of the at least one pallet member, wherein the at least one conveyor module includes at least one engagement member selectively operable to engage the post member, wherein when the at least one engagement member selectively engages the at least one post member, the first conveyor module is selectively operable to cause the at least one pallet member to execute a radially sweeping motion, wherein when the at least one engagement member selectively disengages from the at least one post member, the first conveyor module is selectively operable to cause the at least one pallet member to be transported in a substantially linear motion.

In accordance with another aspect of this embodiment, either of the first or second conveyor modules includes a chain system, wherein the chain system includes a plurality of cooperating link pin members and roller members, wherein a first puck member is disposed on at least one of the link pin members.

In accordance with still another aspect of this embodiment, the first puck member includes an area defining a first through bore, wherein a first end portion of the link pin member is selectively operable to be received in the first through bore. The first puck member has a substantially rectangular configuration and/or a beveled surface portion. A second puck member includes an area defining a second through bore, wherein a second end portion of the link pin member is selectively operable to be received in the second through bore, wherein when the first and second ends of the link pin member are received in the first and second through bores, the chain system is substantially enveloped between the first and second puck members.

In accordance with yet another aspect of this embodiment, either of the first or second conveyor modules includes a chain system, wherein the chain system includes a plurality of cooperating link pin members and roller members, wherein a first puck member is disposed in between two adjacent link pin members. The first puck member has a substantially rectangular configuration and/or a beveled surface portion.

In accordance with a further aspect of this embodiment, the first puck member includes a first groove portion formed on at least one surface portion thereof, wherein a first link pin member is selectively operable to be at least partially received in the first groove portion. A second puck member includes a second groove portion formed on at least one surface thereof, wherein a second link pin member is selectively operable to be at least partially received in the second groove portion, wherein when the first and second link pin members are at least partially received in the first and second groove portions, the chain system is substantially enveloped between the first and second puck members.

In accordance with a still further aspect of this embodiment, a flush adjustment system is operably associated with the chain system, wherein the flush adjustment system is selectively operable to vertically pivotally adjust at least a portion of the chain system.

In accordance with a yet further aspect of this embodiment, the chain system comprises a dual beam system including a first chain member having a first length and a second chain member having a second length, wherein the first length is not equal to the second length.

In accordance with a still yet further aspect of this embodiment, a motorized drive system is operably associated with the chain system, wherein the motorized drive system is selectively operable to cause locomotion of the chain system.

In accordance with an additional aspect of this embodiment, a plurality of post members and engagement members are provided.

In accordance with a still additional aspect of this embodiment, the first orientation or direction and the second orientation or direction are dissimilar.

In accordance with a yet additional aspect of this embodiment, either of the first or second conveyor modules are selectively operable to rotate the at least one pallet member in a clockwise or counterclockwise direction.

In accordance with a still yet additional aspect of this embodiment, either of the first or second conveyor modules include a support roller system for supporting the at least one pallet member as the at least one pallet member attempts to travel onto either of the first or second conveyor modules.

In accordance with a further additional aspect of this embodiment, a pallet enabler system is operably associated with either of first or second conveyor modules, wherein the pallet enabler system is selectively operable to disengage the at least one pallet member from either of the first or second conveyor modules so as to cause the locomotion of the at least one pallet member to cease.

In accordance with a still further additional aspect of this embodiment, either the first or second conveyor modules include a chain system, wherein the chain system includes a plurality of cooperating link pin members and roller members, and further comprises a pass through lateral transfer system operatively associated with the chain system for transporting the at least one pallet member in a direction angled with respect to the chain system. The pass through lateral transfer system includes a second chain system, wherein the second chain system is angled with respect to the chain system. The second chain system includes a third puck member, wherein the second chain system includes an area free of any of the third puck members, wherein the third puck member permits the angled transportation of the at least one pallet member, wherein the area free of any of the third puck members permits the transportation of the at least one pallet member along the chain system.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic illustration of an illustrative pallet conveyor transport systems, in accordance with the general teachings of the present invention;

FIG. 2 is a schematic view of a pallet approaching, then engaging the in-transit type pallet rotate claw on the dual-beam/chain conveyor, wherein upon engagement the pallet rotate claw and the pallet irregular shaped corner post are coaxially aligned (the claw being conveyor mounted to facilitate a 90° CCW pallet rotate), the pallet per the engagement is directed to rotate about the centerline of its irregular shaped corner post 90° CCW, then disengages to continue in its transfer;

FIG. 3 is a schematic view of a pallet approaching and entering the 90° CCW redirection corner intersection in two places: first place on the dual-beam/chain conveyor; and the second place on another dual-beam/chain conveyor, where the pallet exits in its new direction on the dual-beam/chain conveyor, and as leaving has a new radial reorientation (e.g., 180 degrees CW with respect to flow);

FIG. 4 is a schematic view of a conveyor's lift-out/drop-in type motor/reducer drive unit suspended on the flush adjustment feature of the dual-beam/chain conveyor;

FIG. 4a is a side elevation view of a conveyor's lift-out/drop-in type motor/reducer drive unit suspended on the flush adjustment feature of the illustrative dual-beam/chain conveyor;

FIG. 4b is an end elevation view of a conveyor's lift-out/drop-in type motor/reducer drive unit suspended on any of the four illustrative conveyor modules, with or without, the flush adjustment feature;

FIG. 4c is an end elevation view of a conveyor's lift-out/drop-in type motor/reducer drive unit suspended on any of the four illustrative conveyor modules, with or without the flush adjustment feature, showing the two points of separation of the output shaft, wherein the drive unit with output shaft can be lifted up and out;

FIG. 4d is a perspective view of the pivot spine of the flush adjustment feature;

FIG. 4e is a plan view of the slot arrangement in the top of all chain beams, at their drive ends of all conveyor modules;

FIG. 5 is a plan view of a conveyor module's chain beam take-up unit;

FIG. 5a is a side elevation view of a conveyor module's chain beam take-up unit;

FIGS. 5b and 5c are end elevation views of the conveyor module's chain beam take-up unit;

FIG. 5d is a plan view of the slot arrangement in the top of all chain beams, at their take-up ends of all conveyor modules;

FIG. 6 is an end elevation view of the construction of a conveyor module's puck enhanced chain, with its extended chain pins and chain puck options;

FIGS. 6a, 6a1, and 6a2 are a side view, a plan view, and a perspective view (e.g., of the puck only), respectively, of the half complement parallel arrangement option of the puck enhanced chain utilizing puck, i.e., these views represent the illustrative puck that is secured between the extended chain pins for the best overall functionality without issues of chain hop or tilting;

FIGS. 6b, 6b1, and 6b2 are a side view, a plan view, and a perspective view (e.g., of the puck only), respectively, of the half complement off-set arrangement option of the puck enhanced chain utilizing puck, i.e., these views represent the illustrative puck that is secured between the extended chain pins for the best overall functionality without issues of chain hop or tilting;

FIGS. 6c, 6c1, and 6c2 are a side view, a plan view, and a perspective view (e.g., of the puck only), respectively, of the full complement parallel arrangement option of the puck enhanced chain utilizing puck, i.e., these views represent the illustrative puck which is secured between the extended chain pins for the best total functionality and have no issues of chain hop or tilting;

FIG. 7 is an end elevation view of the construction of an alternative conveyor module's puck enhanced chain, with its extended chain pins and chain puck options;

FIGS. 7a and 7a1 are views of an optional puck that can be secured by being pushed directly onto (e.g., centered on) the extended chain pins, which can be applied in similar arrangements (e.g., half parallel, half offset, and/or the like), just as those of the above FIGS. 6a series, 6b series, and/or 6c series;

FIGS. 7b and 7b1 are views of another optional puck that can also be secured by being pushed directly onto (e.g., centered on) the extended chain pins, which can only be applied in a full complement arrangement;

FIG. 8 is a plan view showing the relationship of an in-transit rotate claw, conveyor mounted for a 90° CCW pallet rotation reorientation, per its coaxial function with the irregular shaped corner post of the pallet;

FIG. 8a is an end elevation view showing the relationship of an in-transit rotate claw, conveyor mounted for a 90° CCW pallet rotation reorientation, per its coaxial function with the irregular shaped corner post of the pallet where the upper portion of the pallet corner post engages the in-transit rotate claw;

FIG. 8b is an end elevation view showing the relationship of an in-transit rotate claw, conveyor mounted for a 90° CCW pallet rotation reorientation, per its coaxial function with the irregular shaped corner post of the pallet where the lower portion of the pallet corner post engages a stretched version of the in-transit rotate claw;

FIG. 8c is a sectional view taken along line 8c-8c of FIG. 8a showing the relationship of an in-transit rotate claw, conveyor mounted for a 90° CCW pallet rotation reorientation, per its coaxial function with the irregular shaped corner post of the pallet where the top portion of the pallet corner post engages the in-transit rotate claw;

FIG. 8d is a sectional view taken along line 8d-8d of FIG. 8b showing the relationship of an in-transit rotate claw, conveyor mounted for a 90° CCW pallet rotation reorientation, and its coaxial function with the irregular shaped corner post of the pallet where the lower portion of the pallet post engages a stretched version of the in-transit rotate claw;

FIG. 9 is a schematic view of a pallet approaching and entering the 90° CCW redirection corner intersection on the dual-beam/chain conveyor, where the pallet exits in its new direction on the dual-beam/chain conveyor, and has a new radial reorientation (e.g., 90 degrees CW with respect to flow);

FIG. 10 is a schematic view of a pallet approaching and entering the 90° CCW redirection corner intersection on the dual-beam/chain conveyor, where the pallet exits in its new direction on the dual-beam/chain conveyor, and has a new radial reorientation (e.g., 90 degrees CW with respect to flow);

FIG. 11 is a schematic view of a pallet approaching and entering the 90° CCW redirection corner intersection on the dual-beam/chain conveyor, where the pallet exits in its new direction on another dual-beam/chain conveyor and has a new radial reorientation (e.g., 90 degrees CW with respect to flow), then continues on, approaching and entering the 90° CCW redirection corner intersection, wherein the pallet irregular shaped corner post engages a pallet rotate claw, upon engagement the pallet rotate claw and the pallet irregular shaped corner post are coaxially aligned (e.g., the claw being conveyor mounted to facilitate a 90° CCW pallet rotate), the pallet per the engagement is directed to rotate about the centerline of its irregular shaped corner post 90° CCW, then disengages to continue in its transfer, where the pallet exits to travel a few inches (e.g., just enough to clear for its upcoming new direction of travel), then contacts the outgoing conveyor module's outside guide rail and continues in its new direction on the dual-beam/chain outgoing conveyor, but this time, as leaving, the pallet has no change in its radial reorientation (with respect to flow) per the use and position of the pallet rotate claw;

FIG. 12 is a schematic view of a pallet approaching and entering the 90° CCW redirection corner intersection on the dual-beam/chain conveyor, wherein the pallet irregular shaped corner post engages a pallet rotate corner claw, upon engagement the pallet rotate claw and the pallet irregular shaped corner post are coaxially aligned (e.g., the claw being conveyor mounted to facilitate a CCW pallet rotation, the pallet per the engagement is directed to rotate about the centerline of its irregular shaped corner post 180° CCW, then disengages to continue in its transfer, then continues in its new direction on the dual-beam/chain conveyor, and has a new radial reorientation (e.g., 90 degrees CCW with respect to flow);

FIG. 13 is a schematic view showing the relationship of a corner rotate claw, conveyor mounted for a CCW pallet rotation, at a 90° CCW redirection corner, per its coaxial function with the irregular shaped corner post of pallet, wherein the pallet exits with a resultant 90° CCW change in radial orientation with respect to flow;

FIG. 13a is an end elevation view showing the relationship of a corner rotate claw, conveyor mounted for a CCW pallet rotation, at a 90° CCW redirection corner, per its coaxial function with the irregular shaped corner post of pallet where the upper portion of the pallet corner post engages corner rotate claw, and further, wherein the pallet exits with a resultant 90° CCW change in radial orientation with respect to flow;

FIG. 13b is an end elevation view showing the relationship of a corner rotate claw, conveyor mounted for a CCW pallet rotation, at a 90° CCW redirection corner, per its coaxial function with the irregular shaped corner post of pallet where the lower portion of the pallet corner post engages a stretched version of the corner rotate claw, and further, wherein the pallet exits with a resultant 90° CCW change in radial orientation with respect to flow;

FIG. 13c is a sectional view taken along line 13c-13c of FIG. 13a showing the relationship of a corner rotate claw, conveyor mounted for a CCW pallet rotation, at a 90° CCW redirection corner, per its coaxial function with the irregular shaped corner post of pallet, where the upper portion of the pallet corner post engages the corner rotate claw, and further, wherein the pallet exits with a resultant 90° CCW change in radial orientation with respect to flow;

FIG. 13d is a sectional view taken along line 13d-13d of FIG. 13b showing the relationship of a corner rotate claw, conveyor mounted for a CCW pallet rotation, at a 90° CCW redirection corner, per its coaxial function with the irregular shaped corner post of the pallet, where the lower portion of the pallet corner post engages a stretched version of the corner rotate claw, wherein the pallet exits with a resultant 90° CCW change in radial orientation with respect to flow;

FIG. 14 is a schematic view of a pallet approaching a corner interface bend redirection, wherein the pallet merely transfers through a 45° CCW bend, transitioning off any of the four illustrative dual-beam/chain conveyors, and onto either version of an illustrative dual-beam/chain conveyor (e.g., per different staggered length proportional requirements dictated by the interface angle) wherein the pallet flow is guided by the sweep rail through transfer transition;

FIG. 14a is a schematic view of a pallet approaching a corner interface bend redirection, wherein the pallet merely transfers through a 60° CCW bend, transitioning off any of the four illustrative dual-beam/chain conveyors, and onto either version of illustrative dual-beam/chain conveyor (e.g., per different staggered length proportional requirements dictated by the interface angle) wherein the pallet flow is guided by the sweep rail through transfer transition;

FIG. 15 is a schematic view of a pallet approaching a power on/off unit and pallet enabler on the dual-beam/chain conveyor, wherein the enabler will softly stop, locate and lift the pallet off the conveyor chains, then the power on/off unit transfers the pallet onto or off of the perpendicularly adjacent dual-beam/chain conveyor;.

FIG. 16 is an end elevation view of the construction of the puck enhanced chain, with its extended chain pins and chain puck, utilized on the power on/off unit;

FIG. 16a is a perspective view of the chain puck;

FIG. 16b is an end elevation view of the power on/off unit as located between the dual chains/beams of any of the illustrative dual-beam/chain conveyors and the outgoing perpendicular conveyor modules;

FIG. 16c is a side elevation view of the power on/off unit as located between the dual chains/beams of any of the illustrative dual-beam/chain conveyors and the outgoing perpendicular conveyor modules;

FIG. 17 is a schematic view of a pallet approaching a power on/off unit and pallet enabler on the dual-beam/chain conveyor, wherein the enabler will softly stop, locate and lift the pallet off the conveyor chains, then the power on/off unit transfers the pallet onto or off of either of the perpendicularly adjacent dual-beam/chain conveyors at the left (e.g., with the pallet going) or transfers the pallet onto or off any of the four illustrative dual-beam/chain conveyors at the right (e.g., with the pallet going);

FIG. 18 is an end elevation view of the construction of the puck enhanced chain, with its extended chain pins and chain puck, utilized on the power on/off unit;

FIG. 18a is a perspective view of the chain puck;

FIG. 18b is an end elevation view of the power on/off unit as located between the dual chains/beams of any of the illustrative dual-beam/chain conveyors, which transfers the pallet onto or off of either of the perpendicularly adjacent dual-beam/chain conveyors at the left (e.g., with the pallet going) or transfers the pallet onto or off any of the four illustrative dual-beam/chain conveyors at the right (e.g., with the pallet going);

FIG. 18c is a side elevation view of the power on/off unit as located between the dual chains/beams of any of the illustrative dual-beam/chain conveyors and the outgoing perpendicular conveyor modules as depicted in FIG. 18b;.

FIG. 19 is a schematic view of three pallets wherein each of the three are stopped, lifted off the conveyor module's chain beams, by three individual pallet enabler units (e.g., per each gear-motor and cam roller lift bar and each of their two static cam roller bars), and located such that the far right work-station pallet is precision located, in X, Y, and Z axis planes (e.g., Y plane per the four jack bars), and the two separated pallets to the left (e.g., at on-deck stations) are precision located in the X and Z axis planes and semi-precision located in the Y axis plane (e.g., absent the static cam roller bars), wherein the pallet enablers can be mounted on any of the four illustrative dual-beam/chain conveyors;

FIG. 20 is a schematic view of a pallet stopped, lifted off the conveyor module's chain beams at a work station, by the pallet enabler (e.g., per the gear-motor and cam roller lift bar and each of their two static cam roller bars), and located such that the pallet is precision located, in X, Y, and Z axis planes (e.g., Y axis plane per the four jack bars), wherein the pallet enablers can be mounted on any of the four illustrative dual-beam/chain conveyors;

FIG. 20a is a side elevation view of a pallet stopped, lifted off the conveyor module's chain beams at a work station, by the pallet enabler (e.g., per the gear-motor and cam roller lift bar and each of their two static cam roller bars), and located such that the pallet is precision located, in X, Y, and Z axis planes (e.g., Y axis plane per the four jack bars), wherein the pallet enablers can be mounted on any of the four illustrative dual-beam/chain conveyors;

FIG. 20b is a side elevation detailed view (e.g., with the conveyor module not shown) of a pallet stopped, lifted off the conveyor module's chain beams at a work station, by the pallet enabler (e.g., per the gear-motor and cam roller lift bar and each of their two static cam roller bars), and located such that the pallet is precision located, in X, Y, and Z axis planes (e.g., Y axis plane per the four jack bars), wherein the pallet enablers can be mounted on any of the four illustrative dual-beam/chain conveyors;

FIG. 20c is a side elevation clarification partial view (e.g., with only the gear-motor assembly and partial pallet shown) of a pallet stopped, lifted off the conveyor module's chain beams at a work station, by the pallet enabler (e.g., per the gear-motor and cam roller lift bar and each of their two static cam roller bars), and located such that the pallet is precision located, in X, Y, and Z axis planes (e.g., Y axis plane per the four jack bars), and the pallet enablers can be mounted on any of the four illustrative dual-beam/chain conveyors;

FIG. 20d is an end elevation view of a pallet stopped, lifted off the conveyor module's chain beams at a work station, by the pallet enabler (e.g., per the gear-motor and cam roller lift bar and each of their two static cam roller bars), and located such that the pallet is precision located, in X, Y, and Z axis planes (e.g., Y axis plane per the four jack bars), and the pallet enablers can be mounted on any of the four illustrative dual-beam/chain conveyors;

FIG. 20e is an end elevation clarification view (e.g., with only the chain beam, cam roller lift bar and partial pallet shown) of a pallet stopped, lifted off the conveyor module's chain beams at a work station, by the pallet enabler;

FIG. 20f is an end elevation clarification view (e.g., showing the unit and partial pallet shown) of a pallet stopped, lifted off the conveyor module's chain beams at a work station, by the pallet enabler;

FIG. 20g is an end elevation clarification view (e.g., showing the unit and partial pallet shown of an opposite assembly) of a pallet stopped, lifted off the conveyor module's chain beams at a work station, by the pallet enabler;

FIGS. 20h, 20i, and 20j are three assorted views of a shock absorber system incorporated into the pallet transport system of the present invention;

FIGS. 21, 21a, and 21b are three assorted views of the pallet; and

FIG. 21c is an enlarged views of the cam roller insert of pallet (e.g., 4 required) that engage the cam rollers of the cam roller lift bar of the pallet enabler from underneath.

The same reference numerals refer to the same parts throughout the various Figures.

### DETAILED DESCRIPTION OF THE INVENTION

The following description of the preferred embodiment(s) is merely exemplary in nature and is in no way intended to limit the invention, its application, or uses.

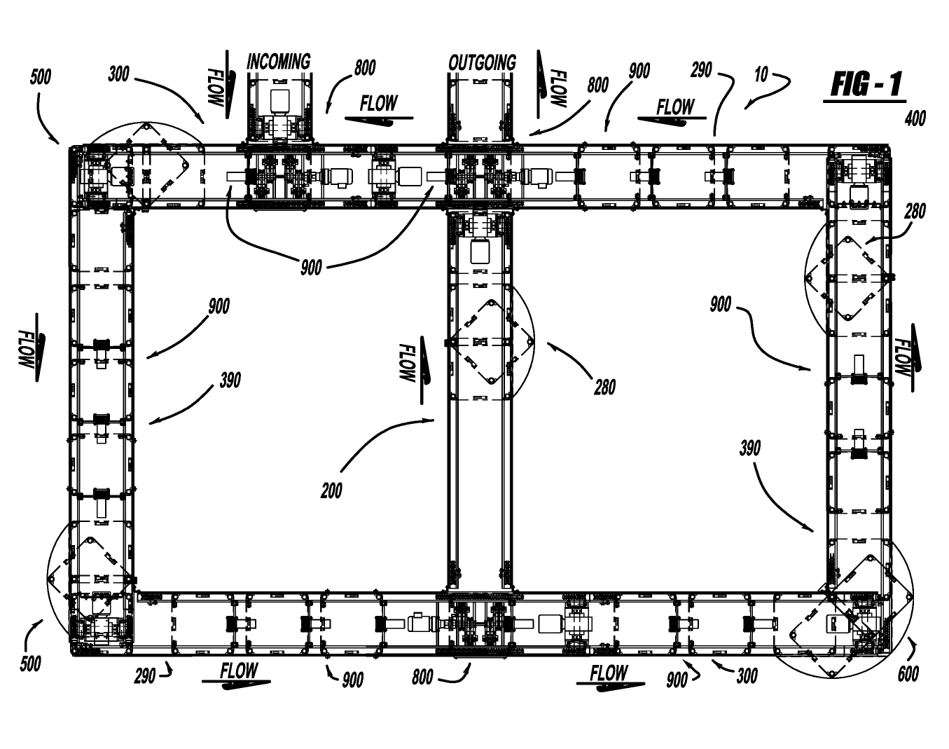

Turning now descriptively to the drawings, the attached figures illustrate an illustrative configurable modular chain pallet transport system generally at 10, e.g., as shown in FIG. 1, which comprises the unique elements and claims of this invention wherein terminology utilized for descriptive purposes of the included drawings is not meant to limit the unique elements and claims of the instant invention. By way of a non-limiting example, if a particular figure illustrates a CCW 90° corner, an unmentioned CCW greater than or less than 90° corner also applies along with all other CW scenarios corresponding thereto.

This invention provides that the system 10 includes dynamic and flexible components that are intended to accomplish two key objectives. The first objective was to eliminate all possible items of non-value added pallet handling equipment and technology found in conventional conveyor systems, thus greatly minimizing both the initial capital costs and life cycle maintenance costs. The second objective was to successfully do this while utilizing a chain type conveyor module approach, having all the advantages of roller conveyors, but with none of their disadvantages, thus further greatly minimizing both initial capital costs and life cycle maintenance costs.

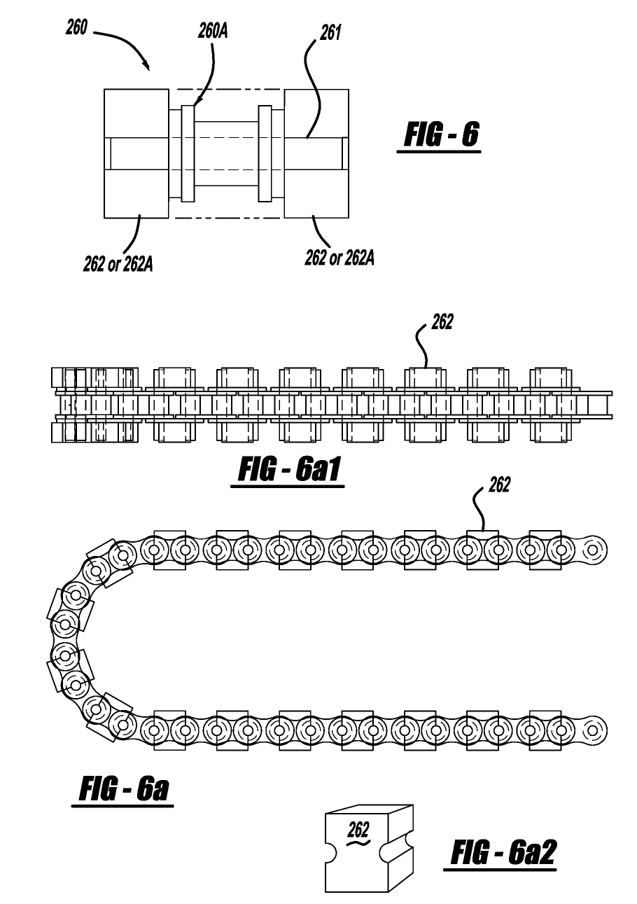

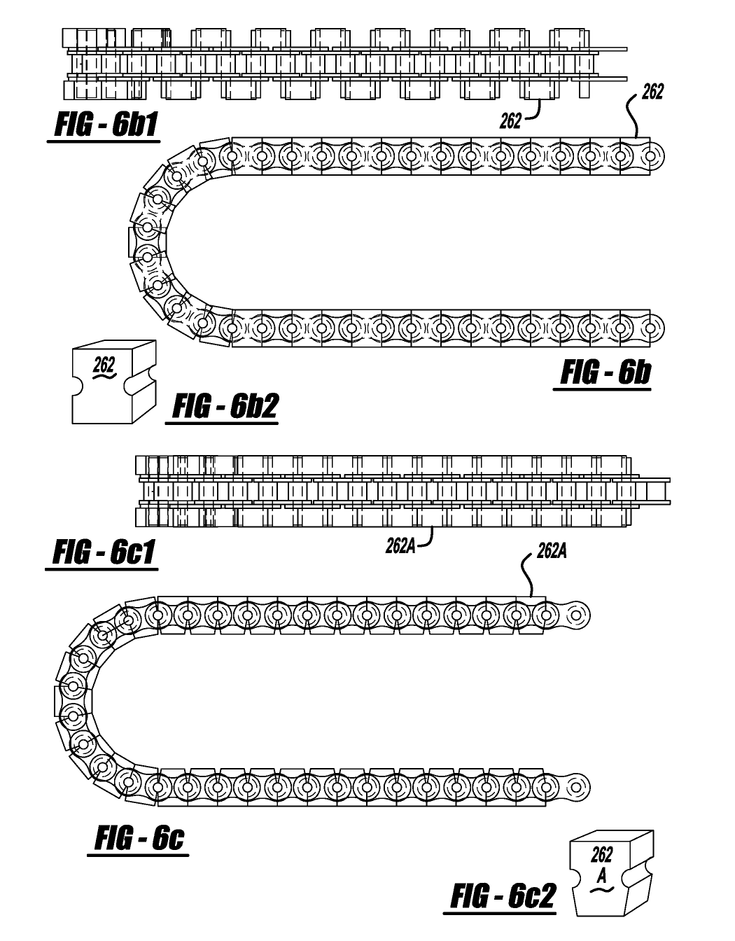

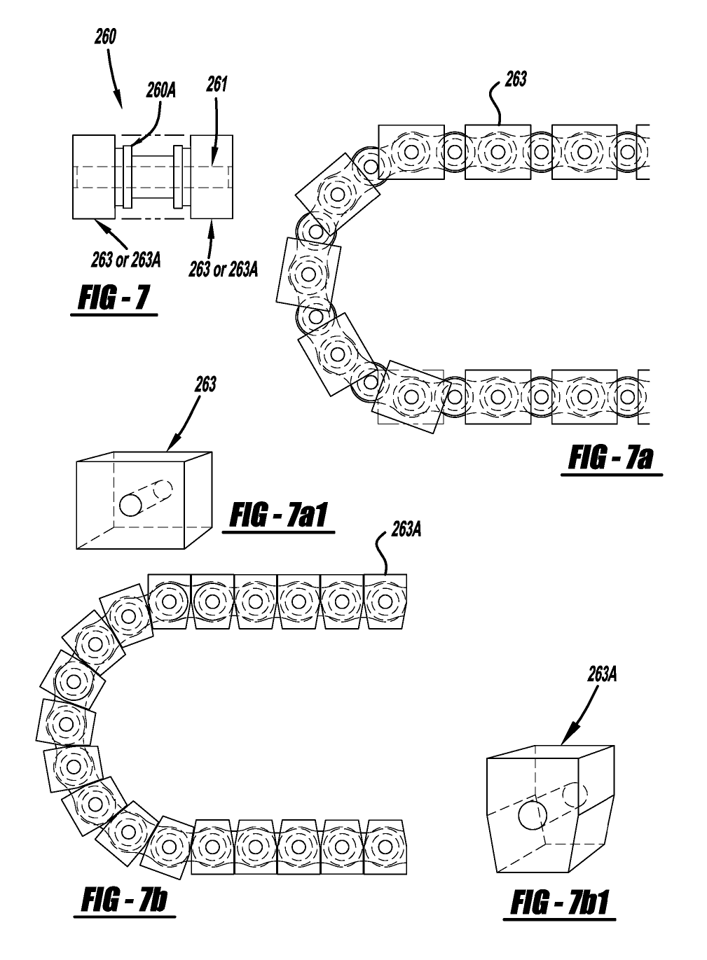

A key feature of this invention is the roller chain 260 of FIGS. 6 and 7 that is essentially standard, except that its link pins 261 are extended out on both sides to enable pucks 262 and 262A (e.g., of appropriate material formulation, shape and arrangement per duty requirements), i.e., the “between pin” pucks of FIGS. 6, 6a2, 6b2, and 6c2, and pucks 263 and 263A, i.e., the optional “over pin” pucks of FIGS. 7, 7a1, and 7b1 to be simply pushed on the chain sides, i.e., between or over the pins. It should be noted that pucks of the present invention can be provided with one, two, or more grooves and/or bores (e.g., through bores) formed on or in a surface portion thereof for receiving, at least partially, one or more of the link pins or portions thereof.

The pucks themselves are designed to be slightly taller than the chain link 260A heights (i.e., tall enough to allow long term wear and ensure that nothing but the drive and take-up sprocket's teeth ever touches the actual steel chain's 260 rollers and links), wherein the chain 260 itself is sandwiched or protected between the pucks, and also suspended (i.e., centered height-wise) by the pucks.

The end-view of the chain, e.g., FIGS. 6 and 7, then becomes a rectangular cross-section (e.g., being very small height-wise) that is able to sustain both compressive loading and sliding friction abuse of any vector dynamic applied on all four sides, and, because the roller chain itself is essentially standard, it provides the strongest chain pull loading possible. In terms of the over-all chain pull loading induced by the compression loading and friction coefficient loading of pallets, all chain pull resultant loading is essentially perfectly central to the chain pins and sprocket pitch diameter. Thus, both the top and bottom surfaces of the pucks are uniformly loaded with effectively no moment loading at all.

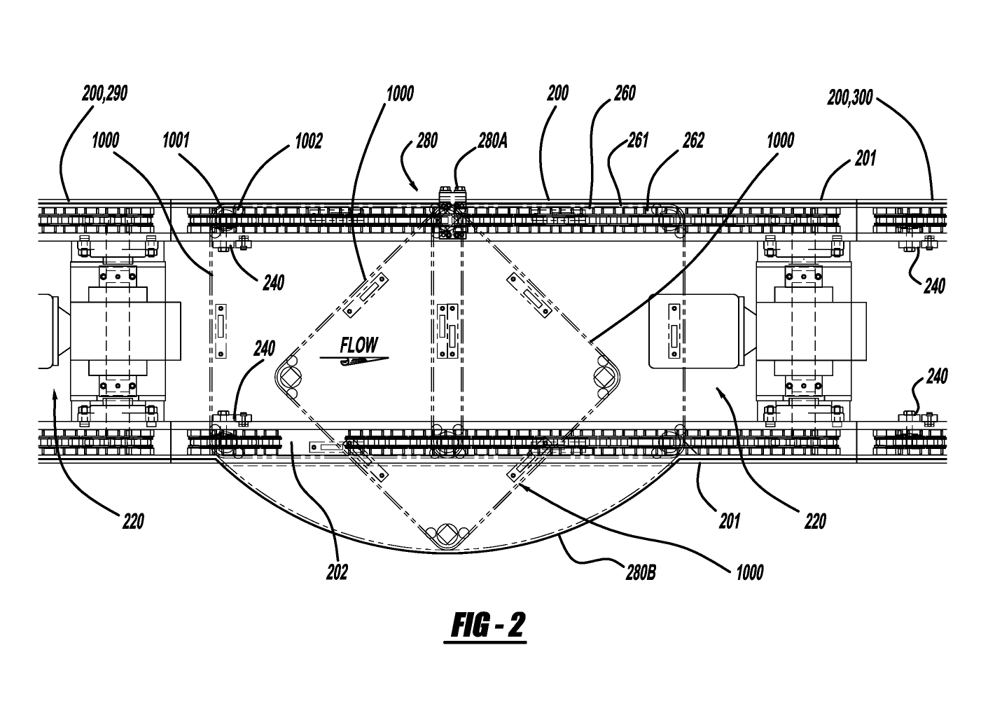

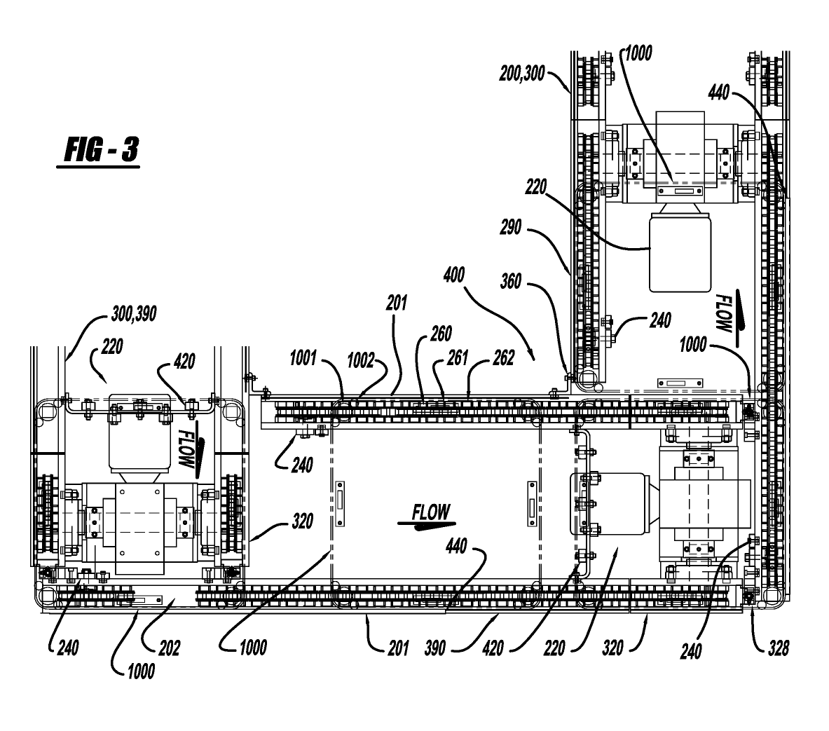

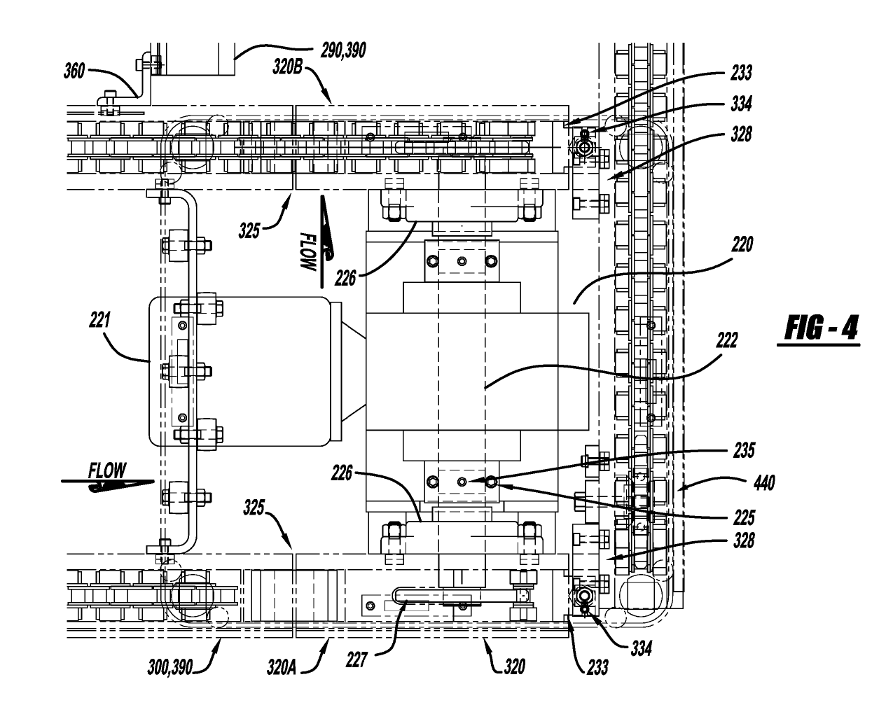

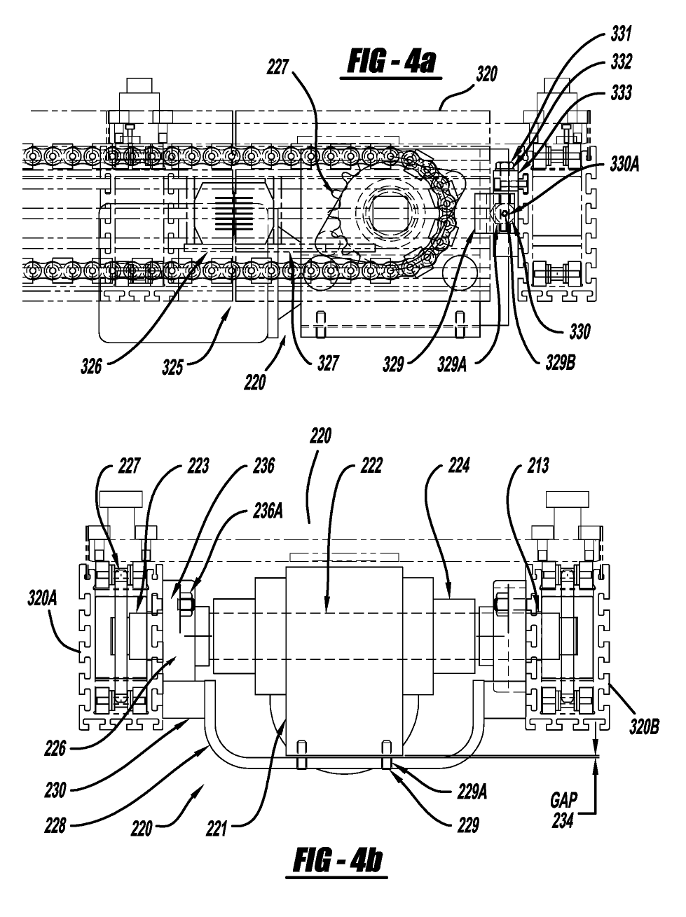

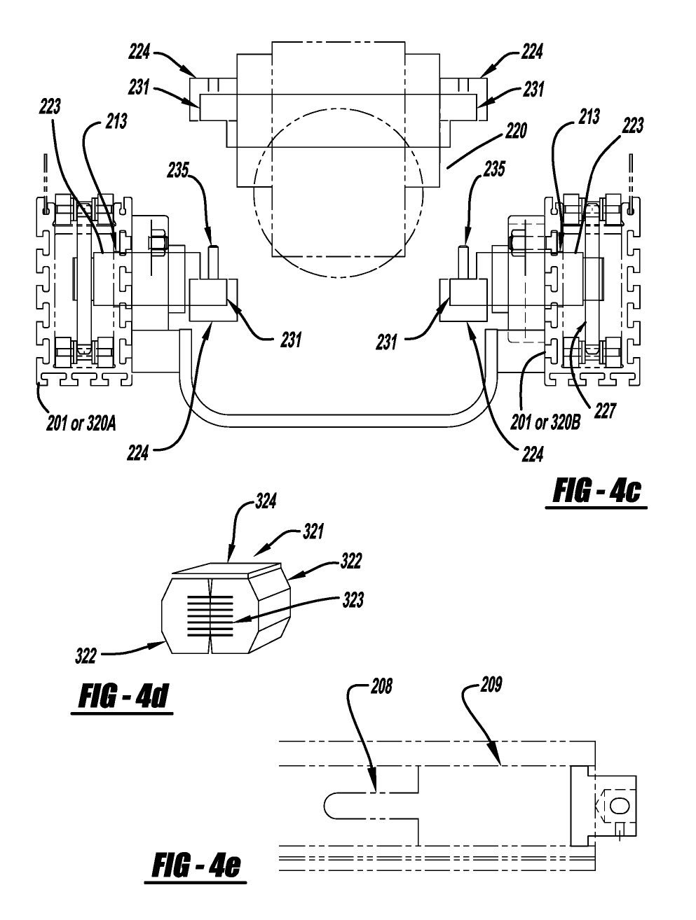

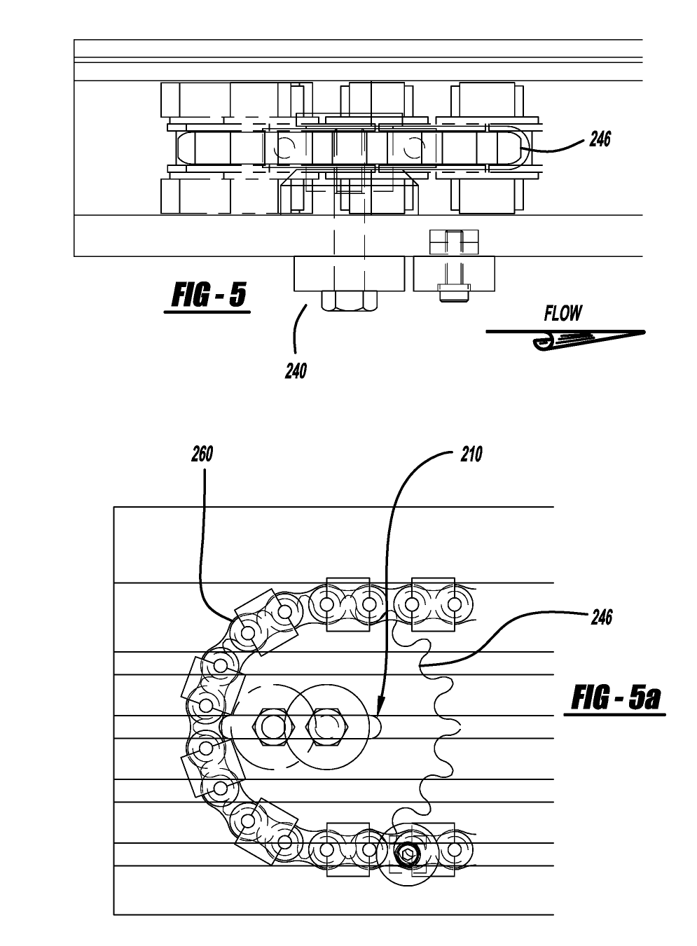

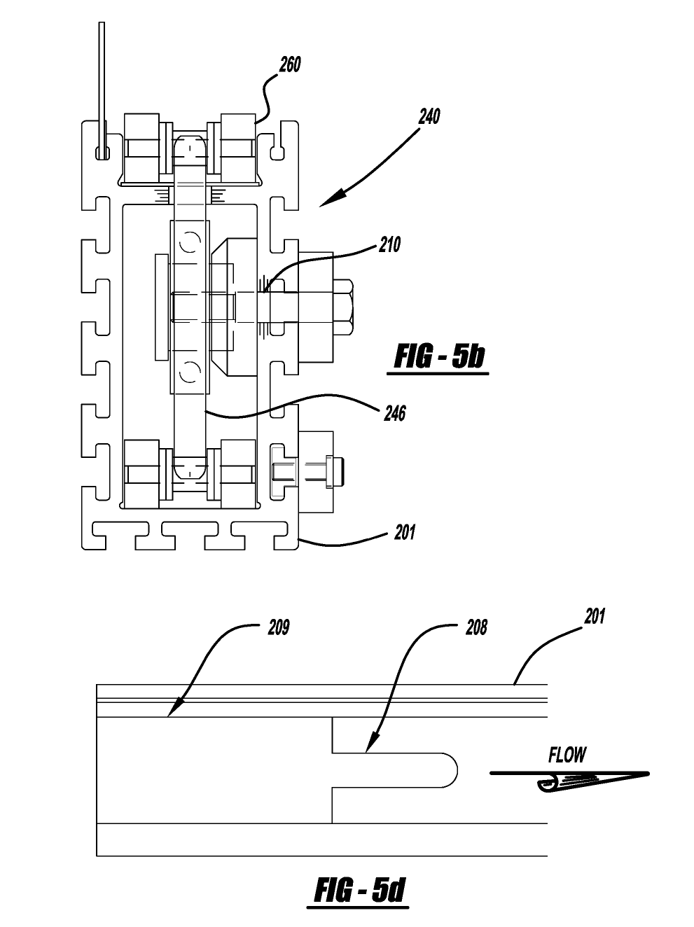

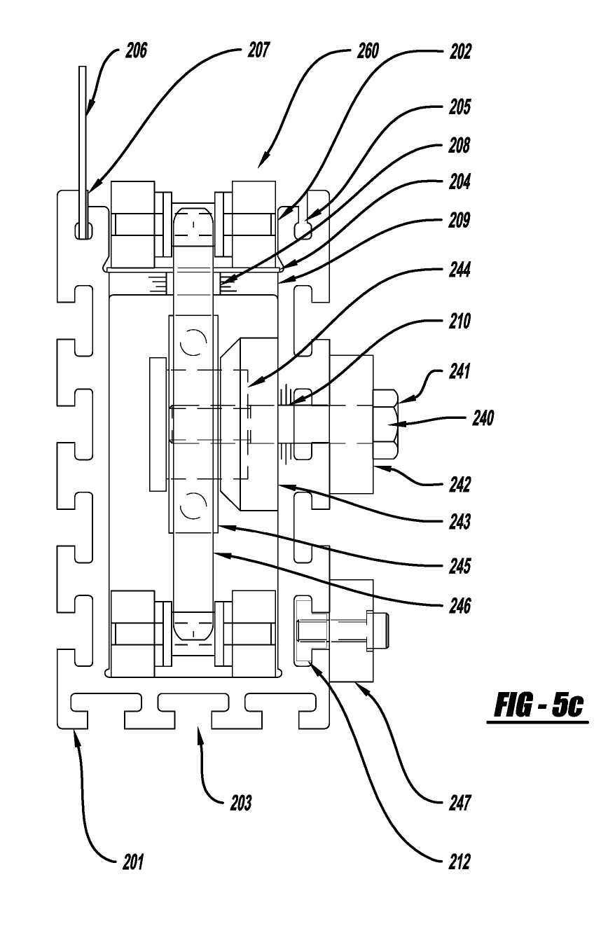

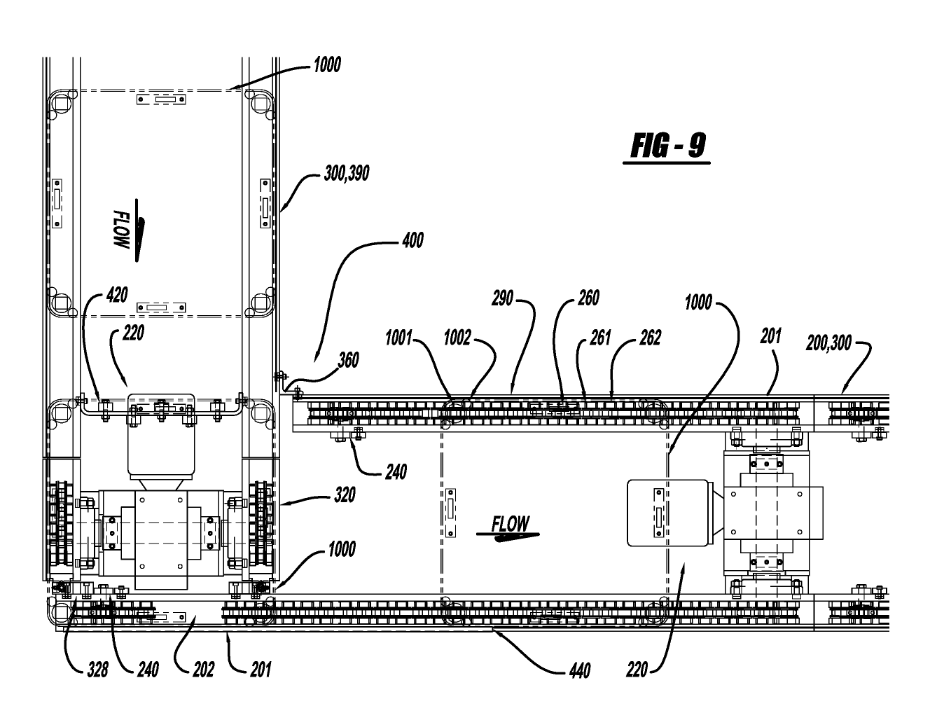

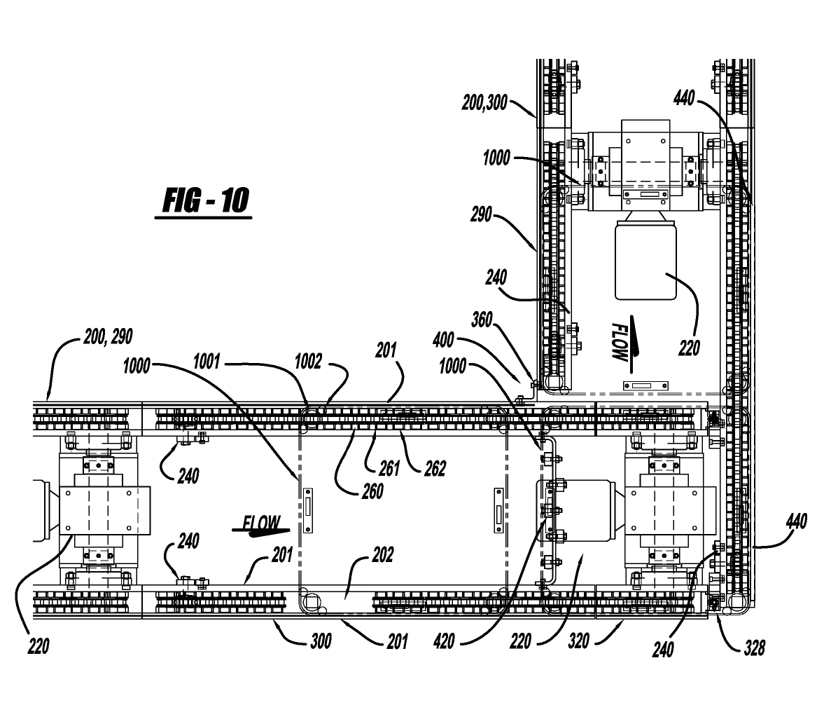

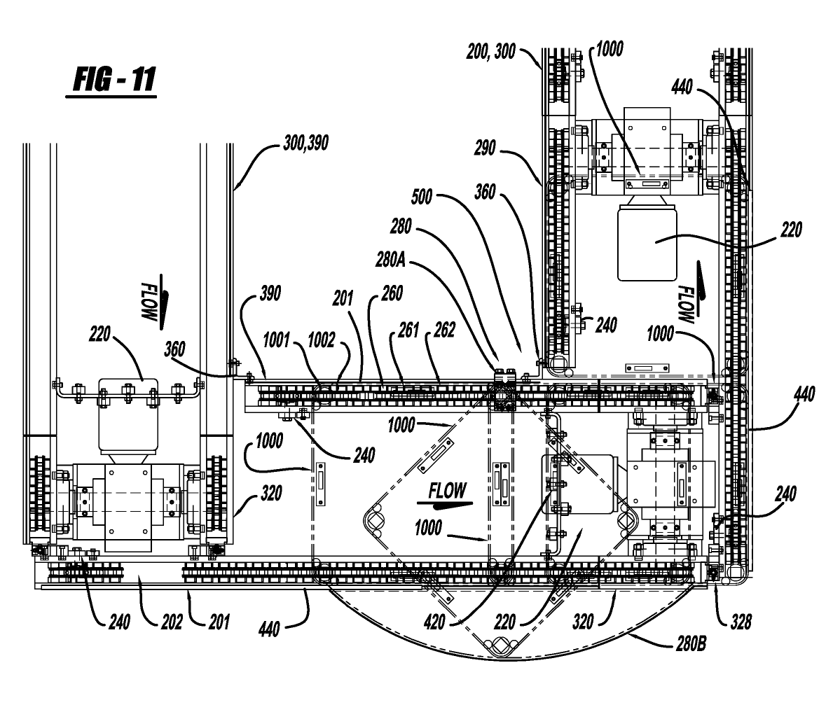

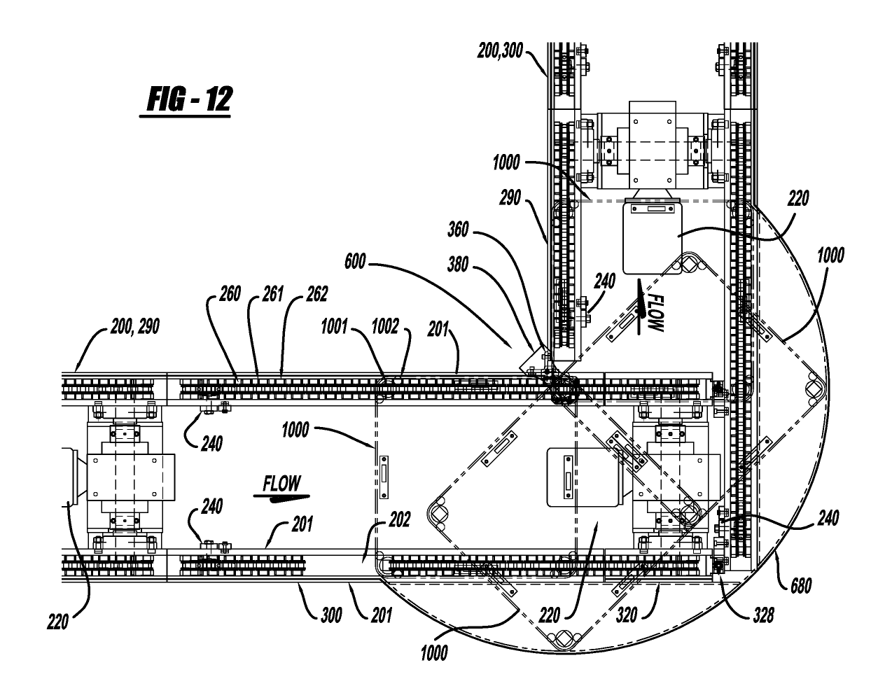

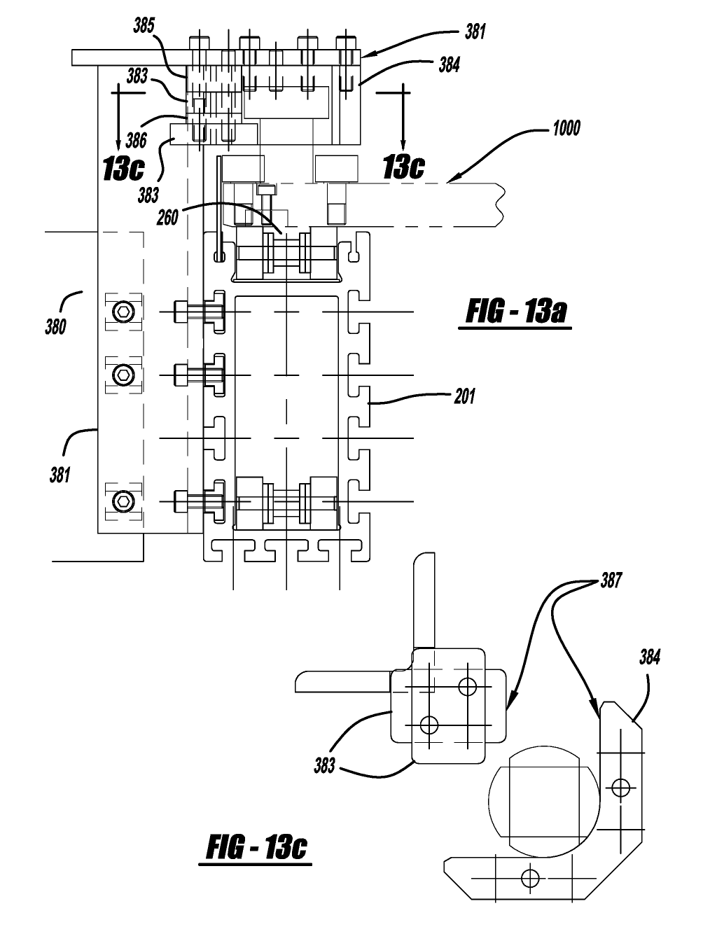

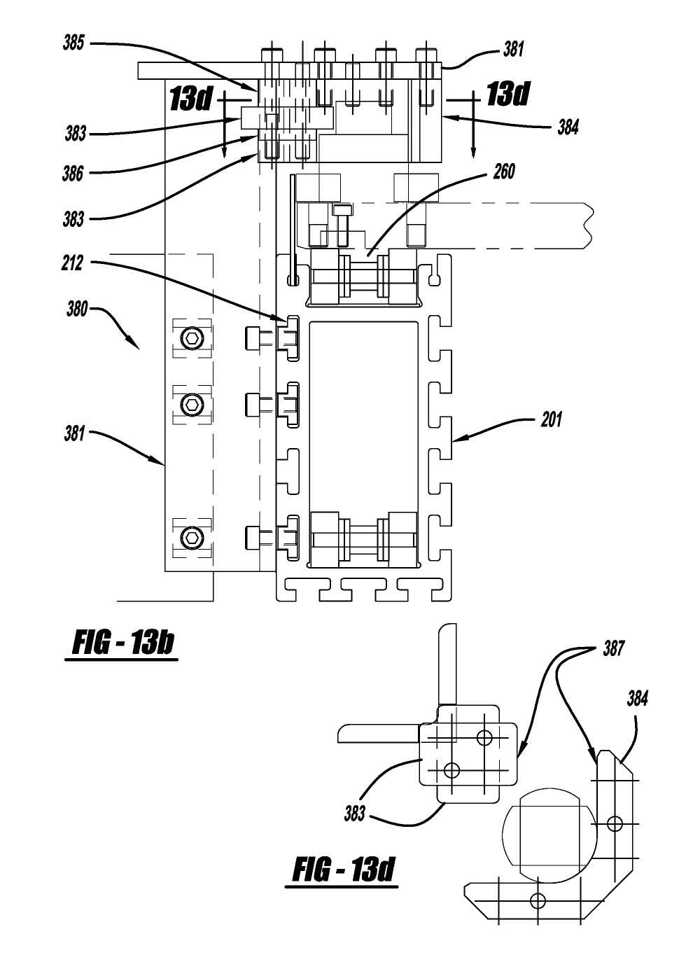

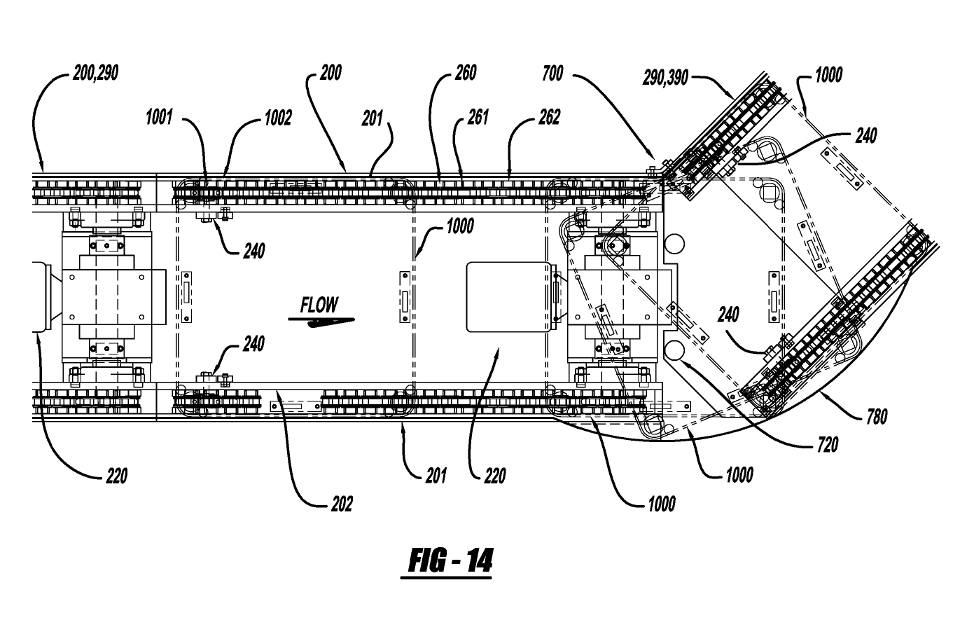

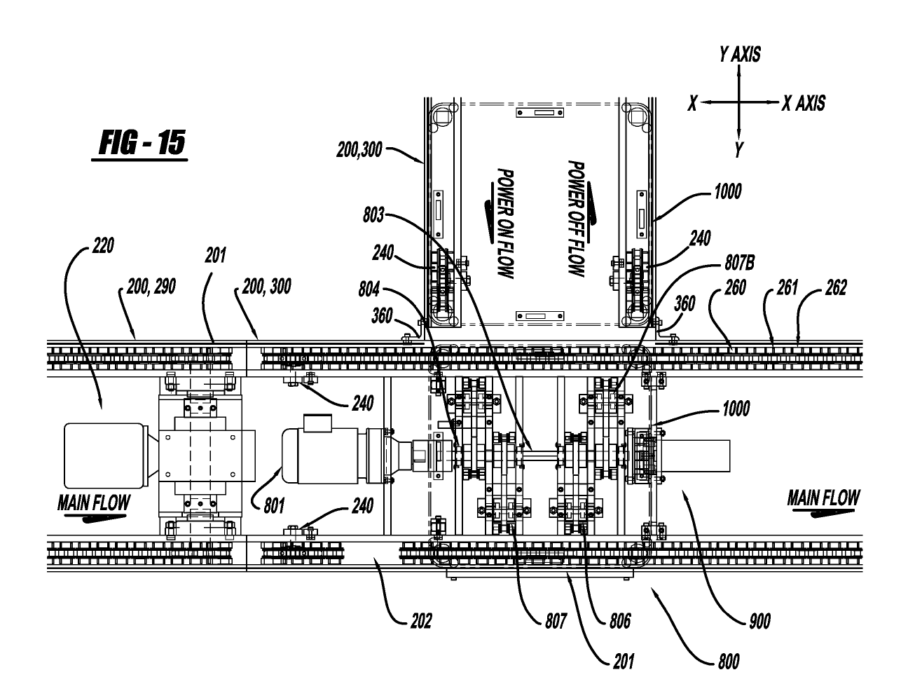

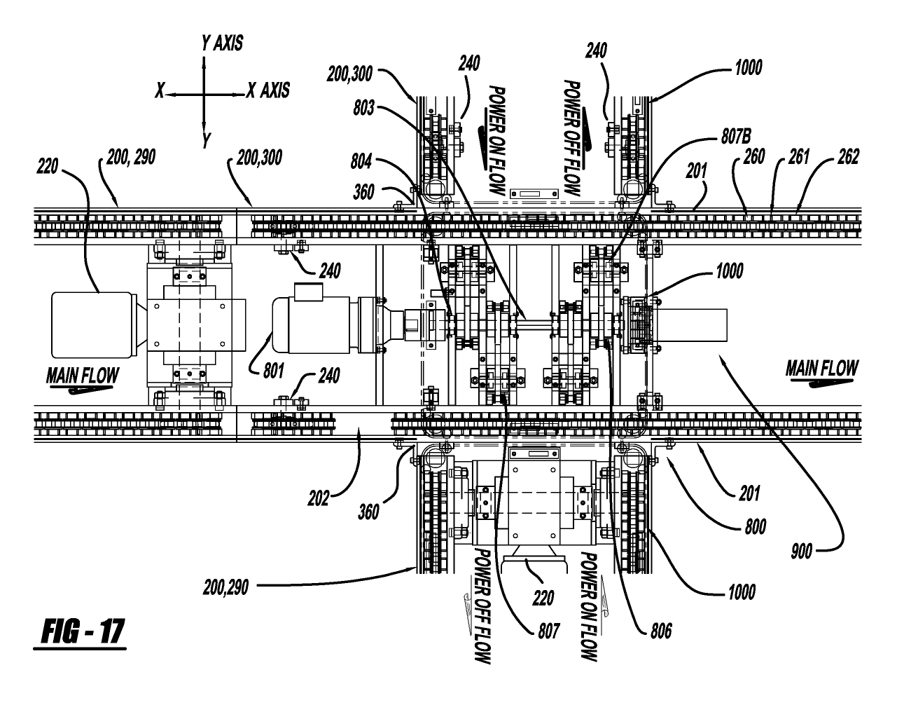

Another feature of this invention is its universally adaptive and flexible conveyor chassis' (i.e., modules) 200, 290, 300, and 390, respectively, wherein the illustrative construction is a dual beam conveyor module. An illustrative module provides each of the rectangular chain beams 201 of FIG. 5c having the same symmetrical hollow aluminum extrusion with ‘T’ slots 203 on the bottom and both sides and with a topside chain channel 202 and optional blue steel channel bed rail 204, and further, each beam having pinch slots 205 on both sides of the chain channel 202 for insertion of a blue steel pallet guide rail 206 in the appropriate outside pinch slot 205 of each of the two spread beams 201 wherein an optional pinch shim 207 may be utilized to secure the blue steel pallet guide rail 206. Both beams 201 of a given conveyor module 200, 290, 300, or 390, respectively, can be top slotted with a common slot 208 and 209 (e.g., see FIGS. 4e and 5d) at each end to facilitate both sprocket removal (e.g., of the drop-in drive sprocket 227 of FIGS. 4, 4a, 4b and 4c, and the take-up sprocket 246 of FIGS. 5, 5a, 5b and 5c), and the chain's clearance as they descend and ascend at the respective drop-in drive 220 end (e.g., see FIGS. 2, 3,4, 4a, 4b, 4c, 9, 10, 11, 12, 14, 14a, 15 and 17) and take-up 240 end (e.g., see FIGS. 2, 3, 4, 5, 5b, 5d, 9, 10, 11, 12, 13, 14, 14a, 15 and 17) (e.g., to re-circulate) at the bottom inside of the extruded chain beam 201. Finally, on the inside front-end sidewall of each chain beam 201 can be a driveshaft hole 213 to facilitate the stub drive shafts 223 of FIGS. 4b and 4c, the drop-in drive 220 of this invention, and, on the inside rear sidewall of each beam can be a take-up slot 210 to facilitate the clamp screw 241 (e.g., see FIGS. 5a, 5b and 5c) of the take-up unit 240.

Another feature of this invention is the four basic conveyor module configurations needed to facilitate all possible system requirements and conditions. These four modules are the uniform length conveyor module 200 (e.g., see FIGS. 1, 2, 3, 9, 10, 11, 12, 14, 14a, 15, 17, 19 and 20), the uniform length conveyor module 300 with flush adjustment feature 320 at the drive end (e.g., see FIGS. 1, 2, 3, 4, 9, 10, 11, 12, 14a, 15, 17, 19 and 20), the staggered length conveyor module 290 (e.g., see FIG. 1, 2, 3, 4, 9, 10, 11, 12, 14, 14a, 15, 17, 19 and 20), and the staggered length conveyor module 390 with flush adjustment feature 320 at the drive end, (e.g., see FIGS. 1, 3, 4, 9, 11, 14, 14a, 19 and 20). The intended purpose of the flush adjustment feature 320 of FIGS. 3, 4, 4a, 4d, 9, 10, 11, 12 and 14a is to have a short built-in portion of the conveyor vertically pivotally adjustable to facilitate uneven chain puck wear over time at angular module interfaces greater than 45°, to adjust the interfacing chain systems of the two involved modules back to a pseudo-flush relationship, thus allowing the rest of the conveyor module to be locked down firmly to the floor (e.g., per the jack plates of low profile/height conveyor systems, or, the jack legs of higher profile/height conveyor systems of any design, which all conveyor module chain beams 201 are generally secured to. This allows the rest of the conveyor module to remain firmly and forever rigid, never to be moved, and therefore never to be moved relative to work stations mechanically tied to the conveyors.

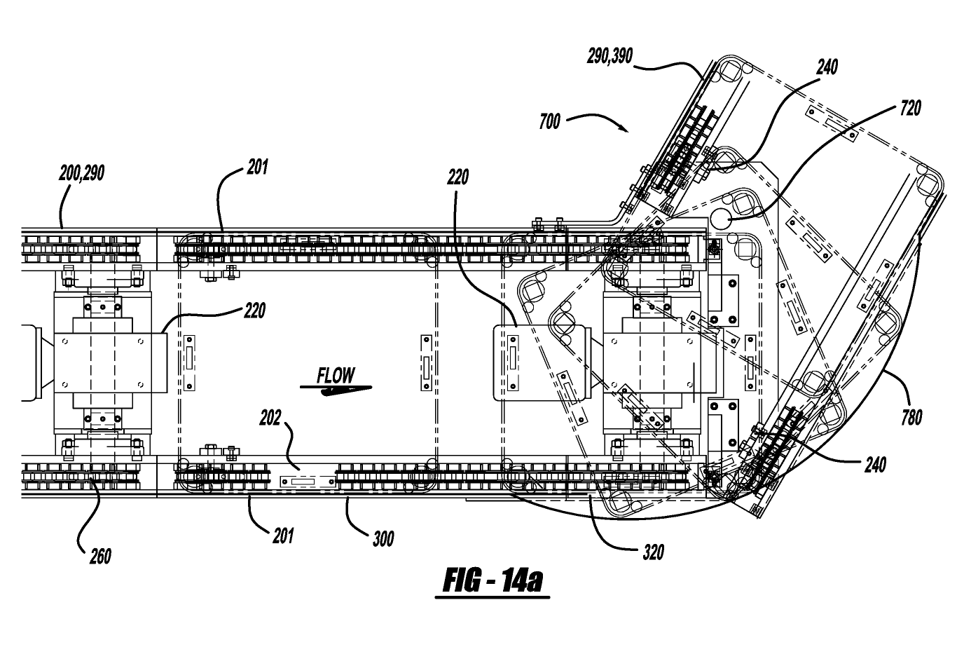

Conveyor module interfaces that are in-line such as in FIGS. 2, 15 and 17, and those with an interface bend up to 45° such as in FIG. 14, will function fine without the need of the flush adjustment feature 320 of FIGS. 3, 4, 4a, 4d, 9, 10, 11, 12 and 14a because of the directness of interface approach as pallets transfer off the front end of one module and onto the other because their two chain systems work in cooperation. Those modules with interface bends greater than 45° should have the flush adjustment feature 320, and those with interface bends of 60° as in FIG. 14a, and greater such as those in FIGS. 3, 4, 4a, 9, 10, 11 and 12 must have the flush adjustment feature 320 because of the increasing trend toward perpendicularity of pallet-to-chain transitional engagement, wherein the two interfacing chain systems, if not adjusted to the pseudo-flush parameter zone, will not function properly in all cases where the incoming module's chains, over time, either wear less or more than the outgoing modules chains, thus either not allowing the pallet to effectively frictionally engage (e.g., as on top of) the outgoing conveyor modules chains, or, having fallen to low to engage (e.g., climb onto) the outgoing modules chains.

Also, it should be noted that, per the illustrative pivot methodology of the flush adjustment feature 320 of this invention of FIGS. 4, 4a, 4b, 4c and 4d, the pivot spine 321 (e.g., as entrapped inside the two chain beams 201 interfacing with chain beams 320A and 320B by the internal structure 326 of chain beams 201 and 327 of chain beams 320A and 320B), with its two coupler segments 322, multiple steel linear springs 323, and centralizing spacer 324, the extrusion gap 325, the jack features 328, the drop-in drive clearance 234, and the torsion bracket 228, that the spread chain beams 320A and 320B are flexibly pliable, in that they can be purposefully vertically distorted about said chain beam pivot spines 321 to give greater versatility for flush adjustments to facilitate the imperfect precision/location of the outgoing conveyor module's chain beams 201.

For the purpose of clarity, here, “pseudo flush parameter zone” simply means that the incoming module's chains at the module's drive sprockets must be a relatively small amount lower than the outgoing module's chains, e.g., to a maximum of about 0.08 inches. Also, it should be noted that the illustrative jack feature 328 of the flush adjustment feature 320 includes two ball housing structures 329 with ball bores 329A and anti-rotate pins 329B of chain beams 320A and 320B, threaded balls 330 with anti rotate holes 330A, jack bolts 331, washers 332, control brackets 333, and lock down set screws 334. To adjust either side of the flush adjustment feature 320, loosen the easily overhead accessible lock down set screw 334, then adjust the chain beam 320A or 320B up or down per the easily overhead accessible jack bolts 331, then re-tighten the lock down set screw 334.

The four innovative conveyor modules 200, 290, 300, and 390, respectively, of this invention will facilitate conveyor system designs of any configuration, e.g., all CW or CCW 90° pallet rotates 280 of this invention, all CW or CCW 0° to 125° corner intersection redirections 400, 500, 600, and 700 of this invention, single or double lateral power on/off 800 transfers of this invention, pallet enablers 900 of this invention which totally control, locate and meter (e.g., stop and release) pallets throughout a given system, and the pallet 1000 product carriers of this invention. Also, it should be noted that the angle tie bracket 360 found throughout the figures of this invention are used to tie (e.g., by way of ‘T’ nuts and screws) conveyor modules to each other.

It is all these chain and conveyor module core innovations of this invention combined, that enables the pallet handling dynamics, that further enable the elimination of the many non-value added mechanical components, functional complexities, controls components and programming content, and equipment life cycle maintenance previously identified.

Another feature of this invention is the drop-in motor/reducer drive 220 of FIGS. 2, 3, 4, 4a, 4b, 4c, 9, 10, 11, 12, 14, 14a, 15 and 17 that are located at the front of each conveyor module, e.g., between the chain beams 201 or 320A and 320B, suspended per its output shaft 222 with interlock ends 231, supported by bearings 226 (which are ‘T’ bolted to the chain beams 201 or 320A and 320B), assembled to the stub drive shafts 223 with interlock ends 231 (which go through the holes 213 in the chain beams 201, or 320A and 320B) by the four screws 225 of the two split clamp collars. It should be noted that the motor reducer 221 is rotationally secured by the torsion bracket 228 (e.g., attached via spacers 230 to chain beams 201 or 320A and 320B) and four jam screws 229 by entrapment only as there is a clearance 234 between the motor reducer 221 bottom face and the torsion bracket 228 and that the four jam screws 229 merely protrude into aligned clearance holes 229A in torsion bracket 228 such that the motor reducer 221 with its output shaft 222 can simply lift out once the four split clamp collar 224 screws 225 are removed, thus the phrase “drop-in drive.” Also, it should be noted that there is a control dowel 235 that goes through both interlocked ends 231 of the output shaft 222 and the interlocked end 231 of each stub drive shaft 223. All motor/reducers 221 with their output shaft 222 can be lifted straight out the top (e.g., unobstructed everywhere a drive exists). Then, if desired, the two stub shafts 223 that drive the two sprockets 227 remain accessible to be laterally pulled out of each sprocket's shaped hole (e.g., simple square, hex, spline, and/or the like) and each beam's double ‘T’ bolted flange bearing 226 (e.g., with ‘T’ bolt 236 and nut 236A). By way of a non-limiting example, a motor/reducer of a drop-in drive could easily be replaced in 2 to 3 minutes.

Still another feature of this invention is the chain take-up which is designed such that it clamps itself to the inside wall of the conveyor module chain beam 201 with the same single bolt 241 that is used for its adjustment. The bolt 241 extends through an external clamp hub 242, through the horizontal slot 210 of the inner wall of chain beam 201, through the internal clamp hub 243, and treads into the flanged bearing boss 244, which goes into the bearing 245, which supports the take-up sprocket 246. Additionally, a leverage hub 247 can be clamped to the same inside wall of the chain beam 201 with a screw and ‘T’ nut 212, below and near the external clamp hub 242. This leverage hub 247 is used as follows when tightening a chain beam's chain. Loosen the bolt 241, then insert anything (e.g., a steel bar, a long wrench, and/or the like) between the external clamp hub and the leverage hub 247, and pull back to the desired tension. Then hold that tension as the bolt 241 is retightened.

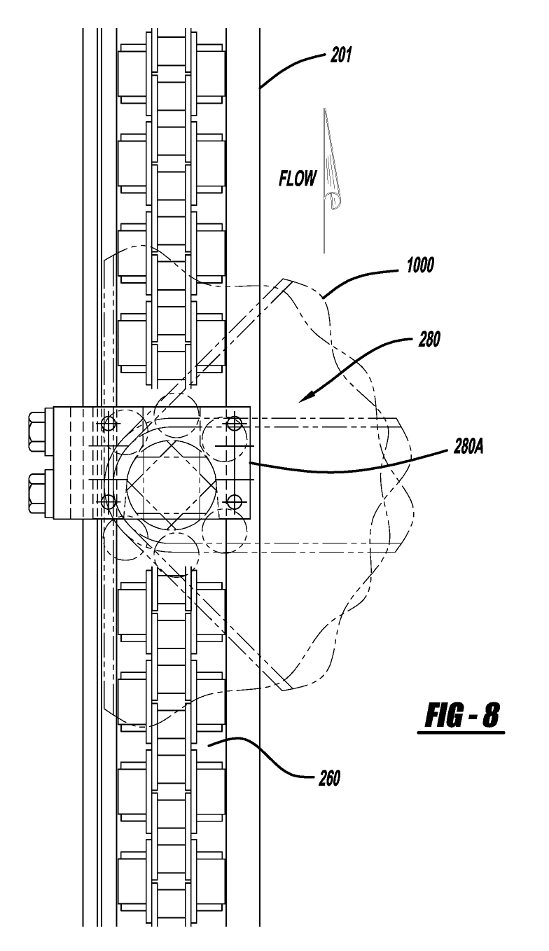

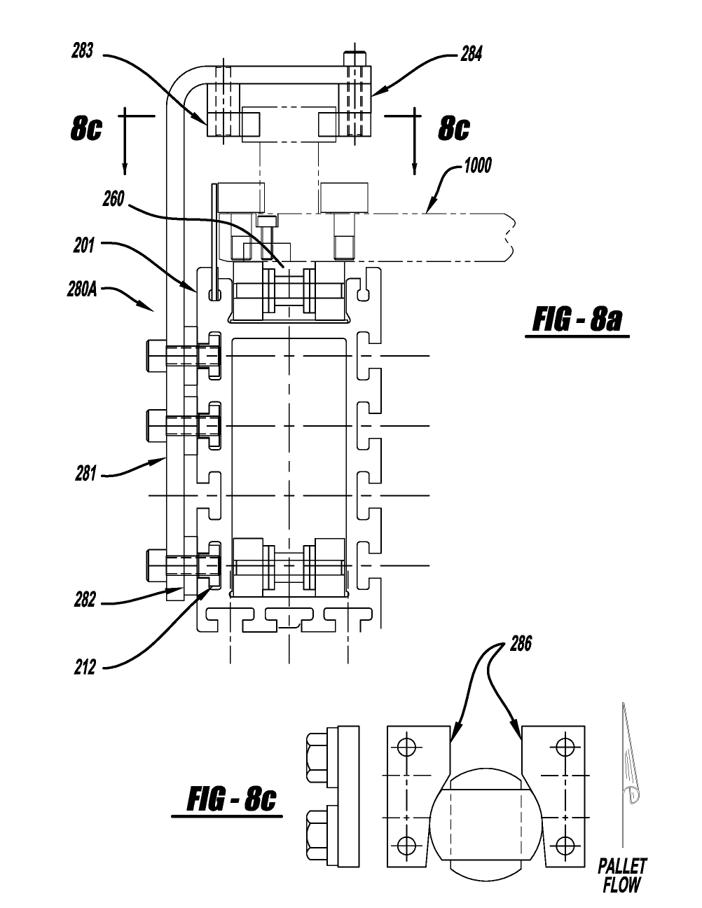

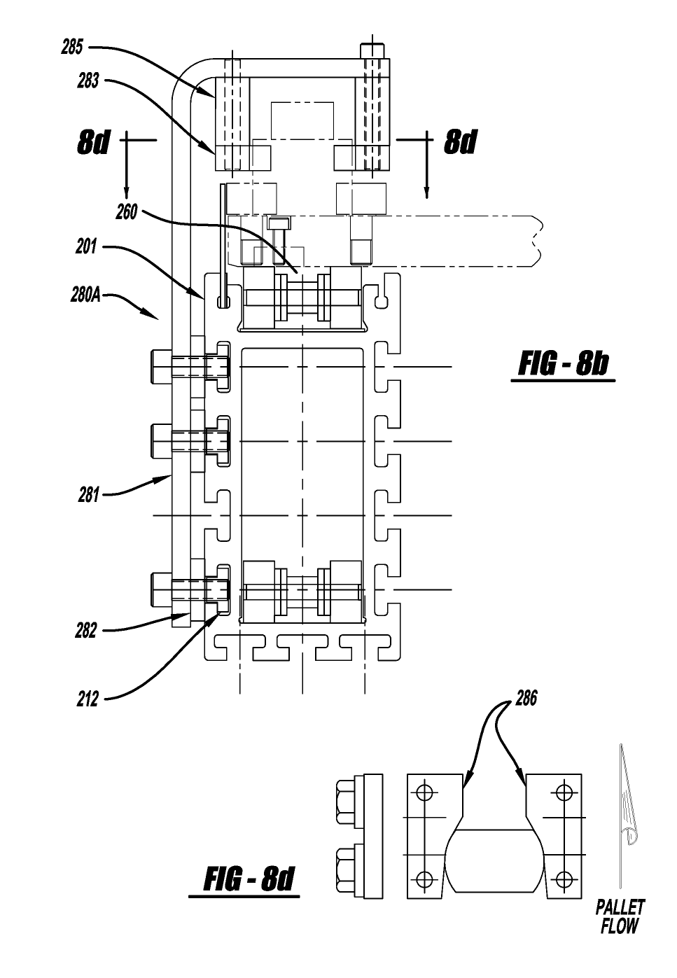

Another feature of this invention was to provide a pallet rotate 280 of FIGS. 1, 2, 8, 8a, 8b, 8c, 8d and 11. The pallet rotate 280 is simply comprised of a very low cost pallet engagement claw 280A and a pallet sweep guard 280B. The pallet engagement claw 280A is static and is mounted on a selected side of a given conveyor module 200, 290, 300, or 390, respectively, depending on the desired direction of pallet rotation of a straight moving pallet 1000. The system pallets 1000 themselves are each provided with four topside irregular shaped pallet posts 1002, one located at each of the pallet 1000 corners. When the moving pallet 1000 reaches the pallet engagement claw 280A, the pallet's left or right irregular shaped lead post 1002 (e.g., either upper segment 1002U or lower segment 1002L) engages the left side or right side conveyor mounted engagement claw 280A (e.g., mounting depending on the desired direction of rotation). This engagement, which restricts the engagement claw 280A side of the pallet 1000 from forward progress (e.g., per the contact fingers 283 positioned by spacers 284 or 285), in conjunction with the continuing movement of the conveyor chains 260, initiates a dynamic moment dictated friction driven radial rotation about the coaxially aligned engagement claw 280A and irregularly shaped pallet post 1002 (e.g., per the pallet's loading on the conveyor's unrestricted opposite side/chain 260) until 90° of rotation has occurred. During this pallet 1000 reorientation/rotate process, the pallet 1000 remains in continual motion (e.g., having never actually been stopped in its transfer) wherein the pallet's 1000 motion simply transitioned from straight to a frictionally skidding radial sweep and then back to straight as it then exits the engagement claw 280A. At this point, the irregular shaped pallet post's 1002 profile is slightly smaller than the engagement claw's 280A built-in pass through opening 286 of fingers 283, enabling the no longer captive and now reoriented pallet 1000 to continue its transfer in the same direction. If a 180° rotation is needed, two pallet engagement claws 280A are simply mounted in immediate series. Also, it should be noted that the claw 280A can be mounted to the conveyor module chain beam per its bracket 281, spacers 282, and secured per the “T” nut's 212 and standard screws.

Another feature of this invention was to also greatly simplify pallet redirection operations, or combinations of redirection and reorientation of pallets exiting corners. With respect to combinations of pallet redirection and radial reorientation scenarios, there are four primary equipment set-ups, each being comprised of simple, statically mounted tooling at the angular intersections of the previously described conveyor modules of this invention.

The first scenario of this invention with respect to pallet 1000 redirection only is the bend 700 of FIGS. 14 and 14a. Here, a conveyor module 200 (e.g., could be 290) interfaces with another conveyor module, e.g., 290 or 390, at a 45° CCW angle for FIG. 14 and/or 60° CCW angle for FIG. 14a. The pallet 1000 merely transfers off the conveyor module 200 and onto the outgoing conveyor module 290 or 390, as supported by the spherical balls 720, in its transfer transition, and as guided by the pallet sweep guard 780. The pallet 1000 continues on in its new direction with the exact same pallet 1000 side leading as when it went in with no radial orientation change with respect to the flow and the centerline of both the conveyor modules 200 and/or 290 or 390.

The second scenario of this invention with respect to pallet 1000 redirection only is the corner 500 of FIGS. 1 and 11. Here, as shown in FIG. 11, an inside (e.g., left side with pallet 1000 going) in-transit type pallet rotate 280 is applied, in that its pallet engagement claw 280A is conveyor mounted just a few inches prior to (i.e., not at) the redirection corner 500, i.e., mounted just shy of the corner 500 as to clear the pallet 1000 when it later exits the corner 500 in its new direction and guarded by pallet sweep guard 280B. When the moving pallet 1000 reaches the pallet engagement claw 280A, the pallet's left leading irregular shaped post 1002 engages the conveyor mounted engagement claw 280A. This engagement, which stops the engagement claw 280A side of the pallet 1000 from forward progress, in conjunction with the continuing movement of the conveyor chains 260, initiates a dynamic moment dictated friction driven radial rotation about the coaxially aligned engagement claw 280A and irregularly shaped pallet post 1002 (e.g., per the pallet's loading on the conveyor's unrestricted opposite side/chain 260) until 90° of rotation has occurred. During this pallet 1000 reorientation/rotate process, the pallet 1000 remains in continual motion (e.g., having never actually been stopped in its transfer) wherein the motion of the pallet 1000 has simply transitioned from straight to a frictionally skidding radial sweep and then back to straight as it then exits the engagement claw 280A. At this point, the profile of the irregular shaped pallet post 1002 is slightly smaller than the built-in pass through opening 286 of the engagement claw 280A, enabling the no longer captive and now reoriented pallet 1000 to continue its short few inches of transfer in the same direction to fully enter into the corner 500. The conveyor configuration is such that the lead or drive end of the incoming conveyor module 390 (e.g., see FIG. 11) interfaces with the staggered chain beam length rear end of the adjacent outgoing conveyor module 290 at a right angle. At this point, the pallet 1000 finds itself suddenly stopped at its front by the outside guide rail 440, and also finds itself on the outside chain 260 of the exiting conveyor module 290 and just as suddenly starts to move in its new direction, laterally transitioning off the outside chain 260 of the incoming conveyor module 390 to be immediately supported by the support rollers 420. The pallet 1000 then, moving in its new direction, transitions off the support rollers 420 and onto the inside chain 260 of the outgoing conveyor module 290, thus now being firmly on both inside and outside beam chains 260 of the outgoing conveyor module 290. The final result being that the initial incoming pallet 1000, having finished the above described process of negotiating the 90° CCW corner 500, ends up with a pallet radial reorientation of 0° , i.e., the pallet 1000 comes out with the exact same pallet 1000 side leading as when it went in with no radial orientation change with respect to the flow and the centerline of both the conveyor modules 390 and 290.

The third scenario of this invention with respect to pallet 1000 redirection is the corner 400 of FIGS. 1, 3, 4, 9, 10 and 11, i.e., where no pallet engagement claw is utilized. Here, as shown in FIG. 3, there are two separate corner 400 interfaces shown. Here, the second corner 400 on the right will be used to explain its function. An incoming pallet 1000 on a conveyor module 390 fully enters into the corner 500. At this point the pallet 1000 finds itself suddenly stopped at its front by the outside guide rail 440, and also finds itself on the outside chain 260 of the exiting conveyor module 290 and just as suddenly starts to move in its new direction, laterally transitioning off the outside chain 260 of the incoming conveyor module 390 to be immediately supported by the support rollers 420. The pallet 1000 then, moving in its new direction, transitions off the support rollers 420 and onto the inside chain 260 of the outgoing conveyor module 290 thus now being firmly on both inside and outside beam chains 260 of the outgoing conveyor module 290. The final result being that the initial incoming pallet 1000, having finished the above described process of negotiating the 90° CCW corner 400, ends up with a pallet radial reorientation of 90° CW. The pallet 1000 comes out rotated 90° CW, with respect to the flow and the centerline of both the conveyor modules 390 and 290.

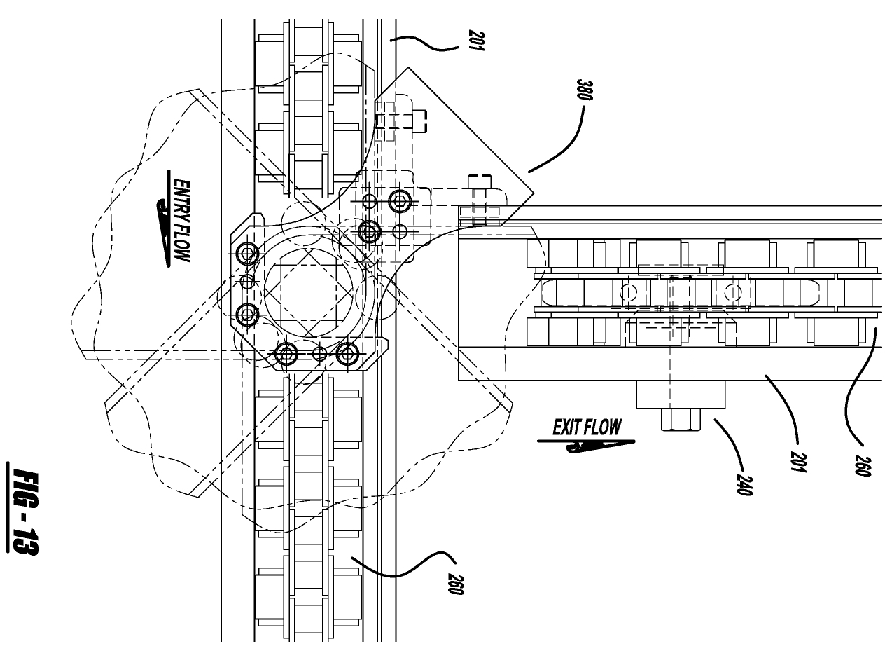

The fourth scenario of this invention with respect to pallet 1000 redirection is the corner 600 of FIGS. 1, 12, 13, 13a, 13b, 13c and 13d where the pallet 1000 is also reoriented and guarded by pallet sweep guard 680. Here, as shown in FIG. 12, an incoming pallet 1000 on a conveyor module 300 approaches the corner 600. The static conveyor mounted corner claw 380 is engaged (e.g., mounted by bracket 381 via “T” nuts 212 with guide details 383 and 384, and spacers 385 and 386 arranged to engage either the upper or lower pallet 1000 post segment 1002U or 1002L, respectively). The conveyor configuration is such that the lead or drive end of the incoming conveyor module 300 interfaces with the staggered chain beam length rear end of the adjacent outgoing conveyor module 290 at a right angle. The pallet 1000 then, per the engagement, in continuous motion starts its dynamic moment dictated friction driven CCW radial rotation about the coaxially aligned conveyor mounted corner claw 380 and irregularly shaped pallet post 1002 engagement, in conjunction with the continuing movement of each of two chains 260, of the two conveyor's 300 and 290 (e.g., per the pallet 1000 loading on both of the conveyor's 300 and 290 unrestricted opposite side chains 260) until 180° of CCW rotation has occurred (i.e., in space). At that point, the irregular shaped profile of the pallet post 1002 is slightly smaller than the built-in pass through opening 387 of the corner claw 380, enabling the no longer captive pallet 1000 to continue its transfer in the new direction and new radial orientation. During this combination pallet 1000 redirection and reorientation process, the pallet 1000 remains in continual motion (e.g., having never actually been stopped in its transfer) wherein the pallet's motion simply transitioned from straight to a frictionally skidding radial sweep and then back to straight as it exits the corner claw 380. Thus, while the pallet direction changes by 90° CCW relative to the centerlines of the two conveyor modules that are running at right angles to each other, the pallet itself is also rotationally reoriented 90° CCW, with respect to the flow and the centerline of both the conveyor modules 300 and 290.

Other simple repositioning possibilities provided by this invention's methodology allow for a myriad of factory floor adjustments, variations, and a myriad of outcomes. It should be understood that anything of CW direction, orientation, or motion can also be of CCW direction, orientation, or motion.

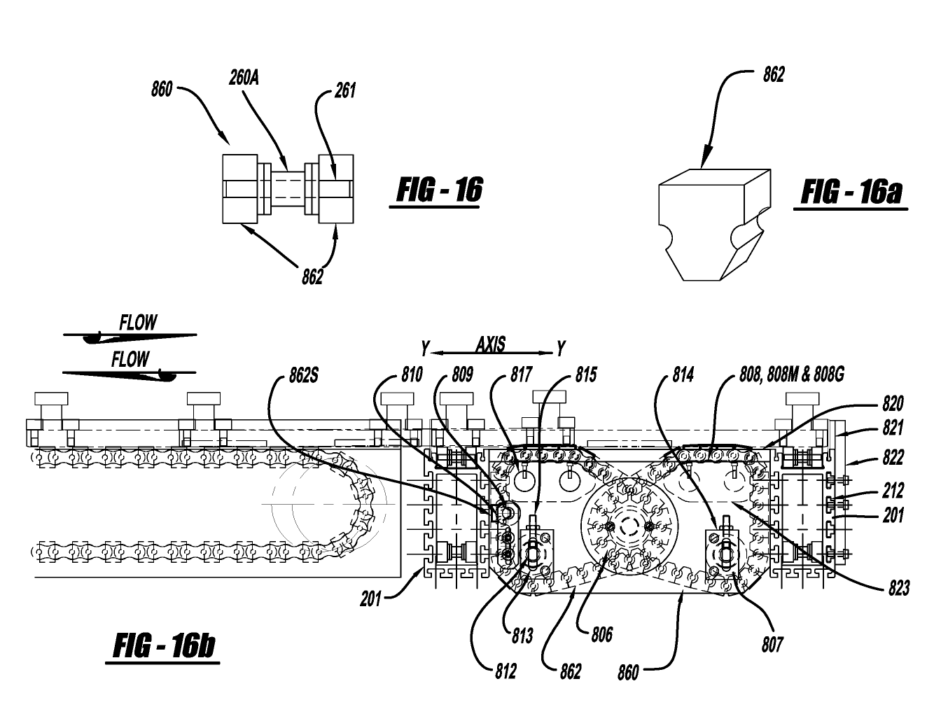

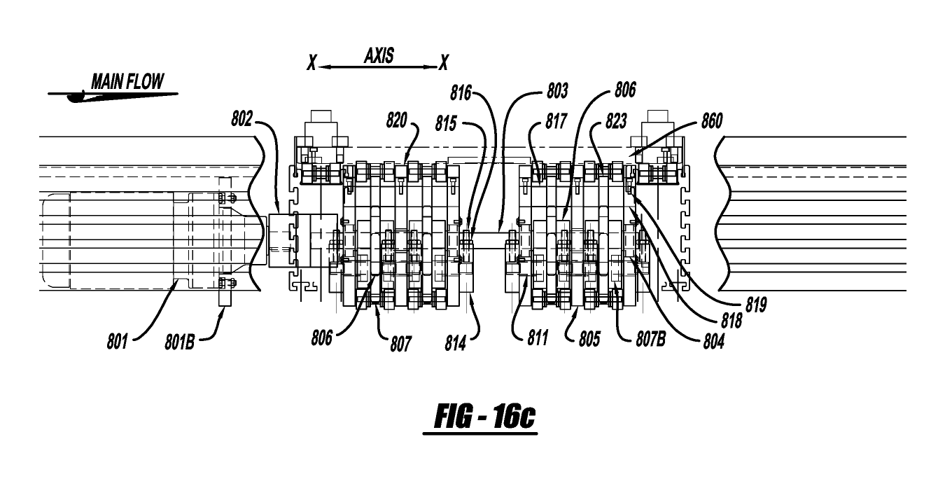

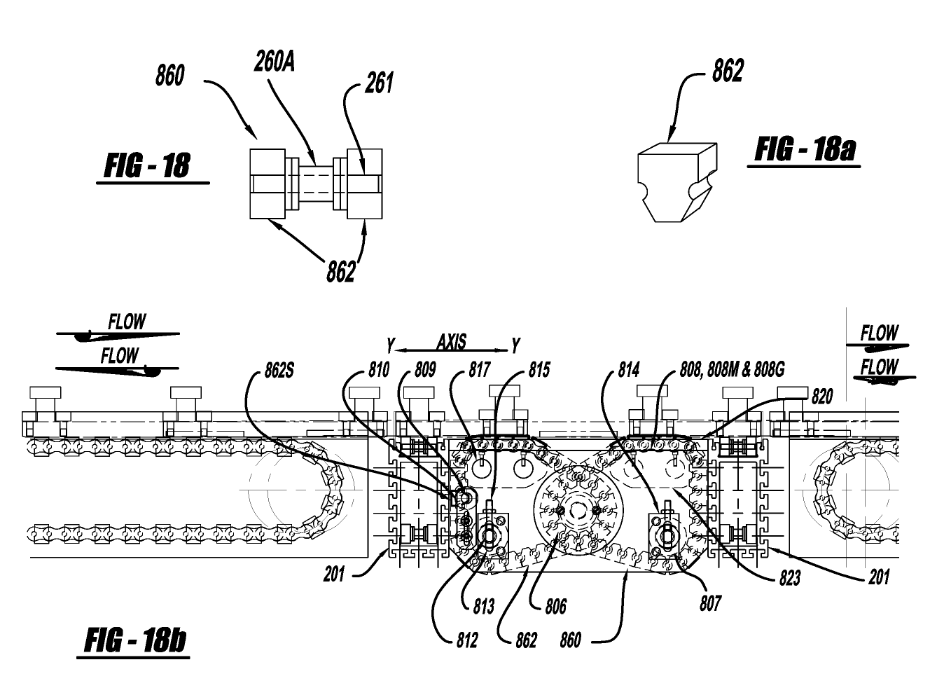

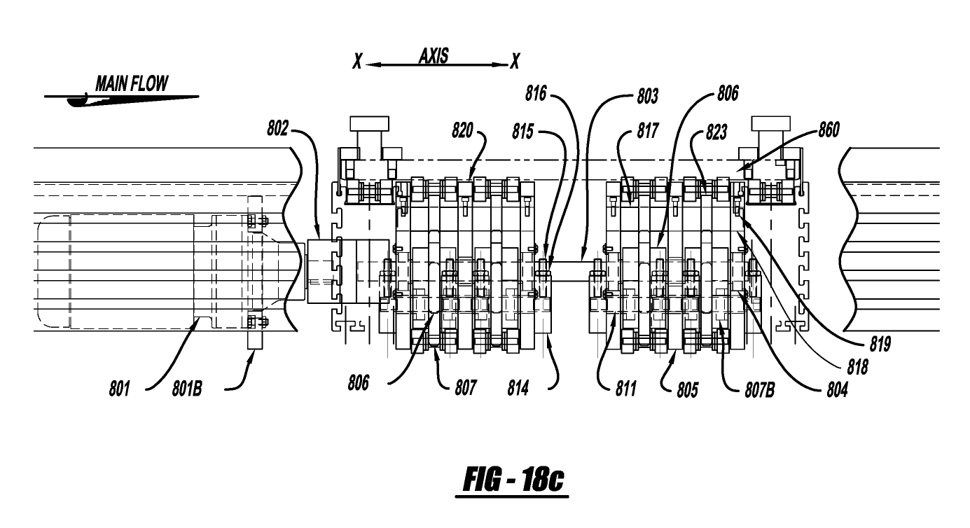

Another feature of this invention is the lateral transfer power-on/off 800 of FIGS. 1, 15, 16a-16c, 17 and 18a-18c. When an incoming pallet 1000 is stopped and positioned (e.g., per an enabler 900 of this invention) for lateral transfer, the motor drive unit 801, mounted to bracket 801B (e.g., ultimately mounted to conveyor module chain beams 201) of the power-on/off 800 turns on in the desired lateral transfer direction (e.g., to transfer a pallet 1000 on to the conveyor module in which the power on/off resides or transfer a pallet 1000 off to an outgoing perpendicularly situated conveyor module). The drive unit 801 and coupling 802 drives a single drive shaft 803 supported by four bearings 804 housed in four main plates 805 (e.g., ultimately mounted to conveyor module chain beams 201), wherein the drive shaft 803 drives four sprockets 806 and chain strands 860 which roll around four idler sprockets 807 and the four chain rails 823 (this description is based on the illustrative quantity of four, e.g., as shown, however this invention is not meant to be limited to this number). Each chain strand 860 circulation route is essentially triangular in shape, but ultimately they are rectangular in shape per the top-flatted pallet support segment 808 of each rail 806. Further, two of the rail's flatted pallet support segments 808 are situated as proximate as possible to one conveyor module chain beam 201 while the other two flatted pallet support segments 808 are similarly situated as proximate as possible to the other conveyor module chain beam 201 (e.g., being a mirror image), to provide an as wide as possible pallet 1000 footing stability in the Y direction during the power on/off process. The chain strands 860 of this power on/off 800 are exactly the same as the chain of the conveyor modules. The only difference is that the puck 862 of the power on/off 800 has a more pronounced bevel per its smaller running radius (e.g., around each rail 806) than the beveled puck 262A of the conveyor modules. As the power-on/off 800 turns on (e.g., in the desired lateral direction) to transfer a given pallet 1000 onto or off of an adjacent abutting conveyor, there are no motion/device requirements beyond that of the power-on/off 800 unit's moving chains 860 that laterally transfers the pallet 1000 to or from an incoming or outgoing adjacent conveyor of perpendicular orientation and of common height.

When waiting for a pallet 1000 to arrive, there is a segment 808M of missing pucks 862 on each chain strands 860. This segment 808M of missing pucks 862 will be in the up position in coordination with the top-flatted pallet support segment 808 of each rail 806, such that pallets 1000 can pass overhead (coming in, going out or just passing through), in that there is clearance between the pallet 1000 bottom and the chain strands 860, per the missing pucks 862, and the actual chain links 260A in the segment length 808M are ground down on top 808G to ensure a 0.125 inch approximate clearance. When a pallet is to be laterally transferred, upon being turned on, the missing pucks 862 of the chain strands 860, riding on the chain rails 806 move (e.g., roll) up from below (e.g., as per the purposefully established as wide as possible pallet 1000 footing of their flatted pallet support segments 808 of chain rails 806) in the direction of transfer. The two inner strands 860 of the ascending pucks 862 emerge forward of the center, and the two outer strands 860 of the ascending pucks 862 emerge nearer to the trailing pallet 1000 end. Both sets of the two below awaiting full complement strands of pucks 862 (e.g., less the segment 808), in their transitional travel from upwards radial, to horizontal, per their just stated distribution of stability, lift the pallet 1000 a minor distance off the conveyor module's chain 260 and transfer the pallet 1000 on or off as needed. When being powered on, the short distance that a pallet 1000 interfaces with the frictionally conflicting common height chain 260 of the conveyor module in which the power on/off resides, the friction conflict is rendered inconsequential because the conveyor module of delivery maintains control of the pallet 1000 per its pallet guide rails 206, at which point the chain pucks 862 lift the pallet 1000 as previously described to maintain control as it transfers the pallet 1000 on. Because all conveyor modules of a given system of this invention are of common height, it is obvious that per the minor height increase delivered by (as necessary) the ascension of the power on/off 800 unit's chain pucks 862, in its function, that there is a transitional travel distance zone in both directions where the pallet 1000, in its transfer motion to and from adjacent incoming/outgoing conveyor modules, goes from level to mildly tilted and back to level (which is generally undetectable to the human eye).

Further, there is a single zero position start/stop sensor 809 and bracket 810, which is actuated by a metal puck dog 862S located on one of the outside chain strands 860. The outer idler sprockets 807, running on eight bearings 807B, are supported on four shafts 811 which have anti-rotation flats 812 at their ends, which fit into slots 813 in brackets 814, mounted to main plates 805. Chain slack is removed by the tightening of the eight setscrews 815, which are imposed against the ends of the shafts 811 and the coaxial tightening of accompanying jam nuts 816. Chain rails 806 are suspended on cross-pins 817 which are secured in the bores 818 in main plates 805 by screws 819. Six rails 820 entrap the chain four strands 860 in the vicinity of the upper segment 808. Impact rail 821, secured to back-up plate 822 which is mounted to chain beams 201 per “T” nuts 212 and standard screws, are employed when the power on/off functions in the power on mode.

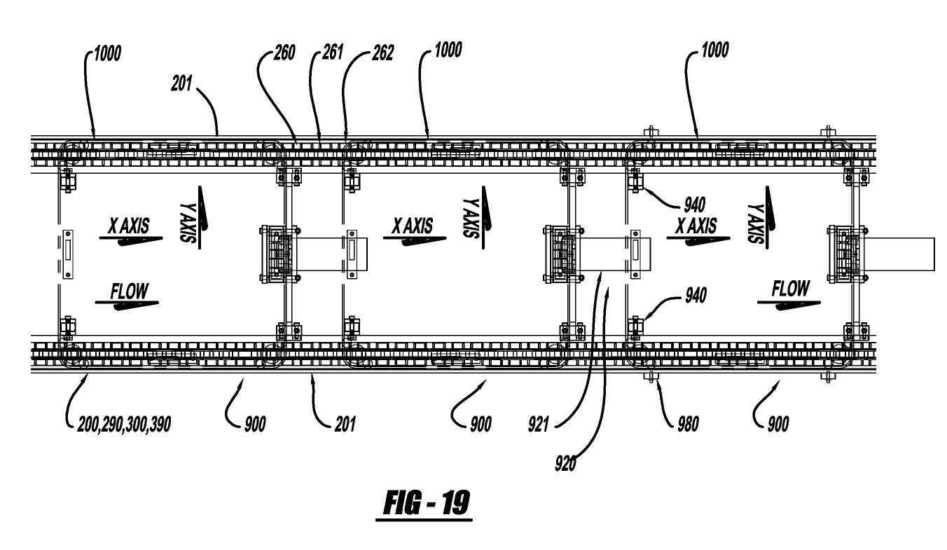

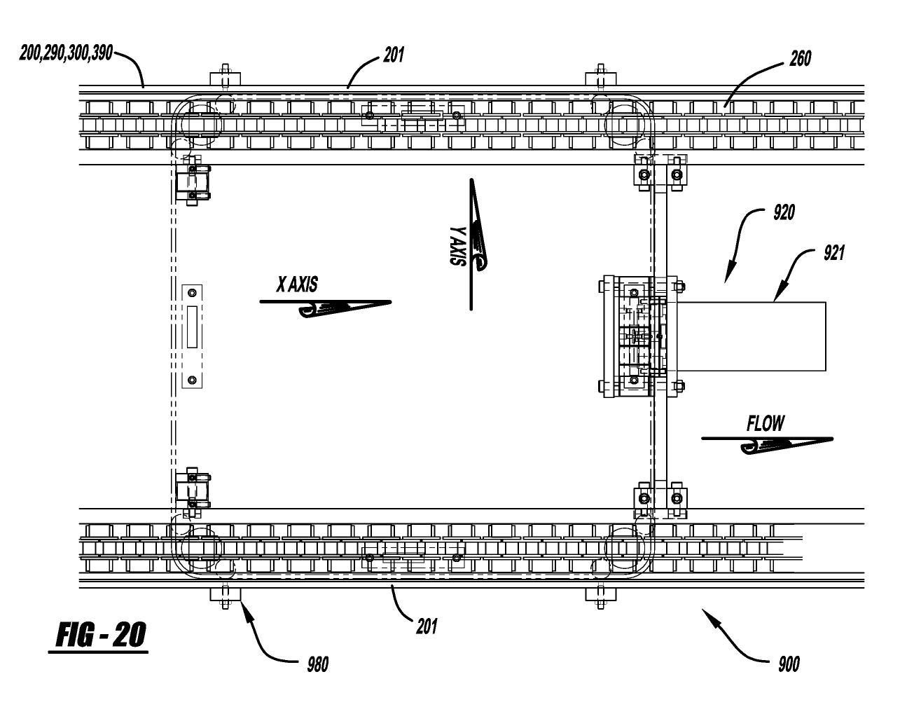

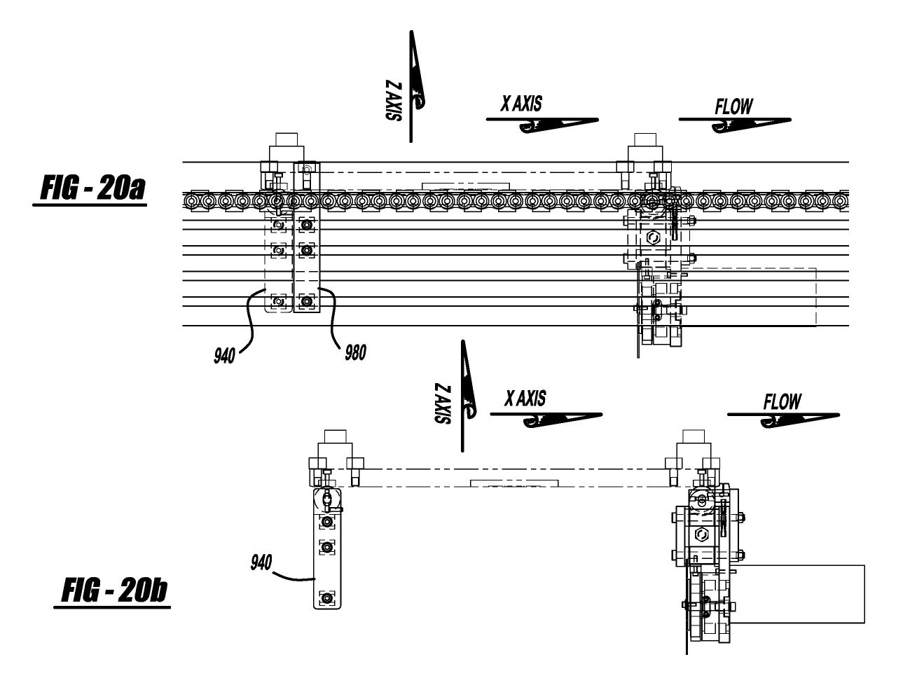

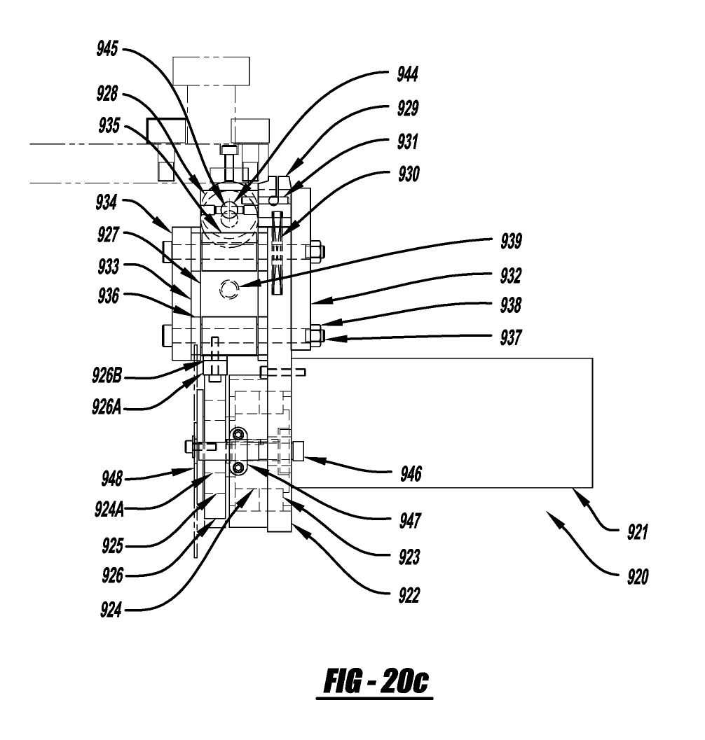

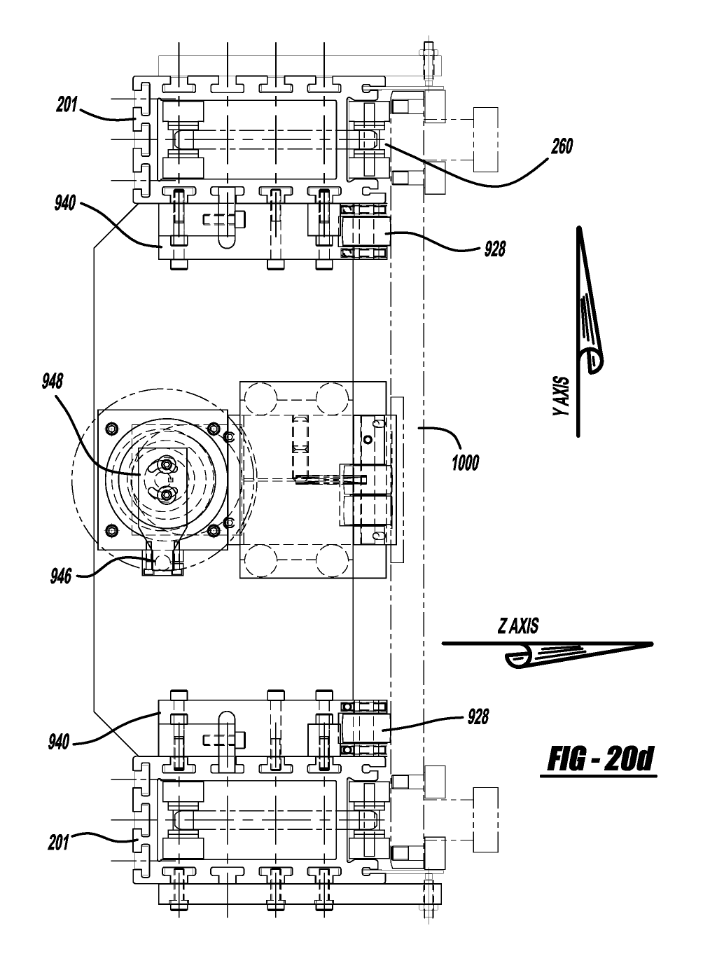

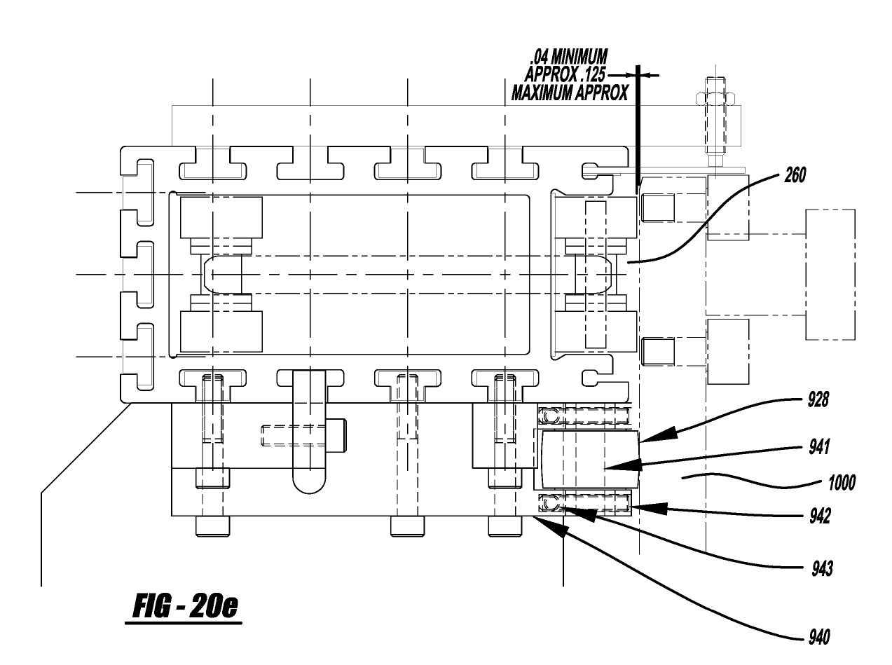

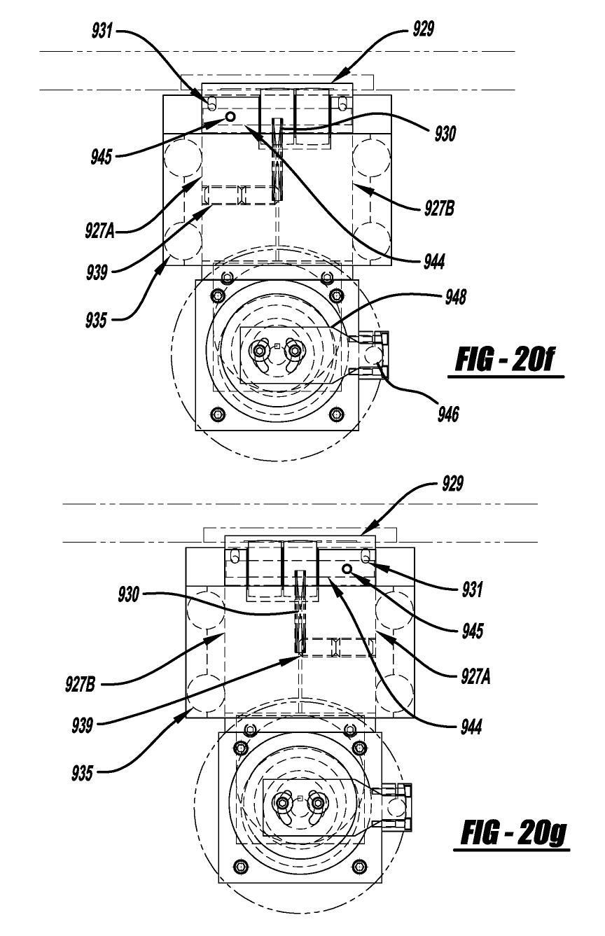

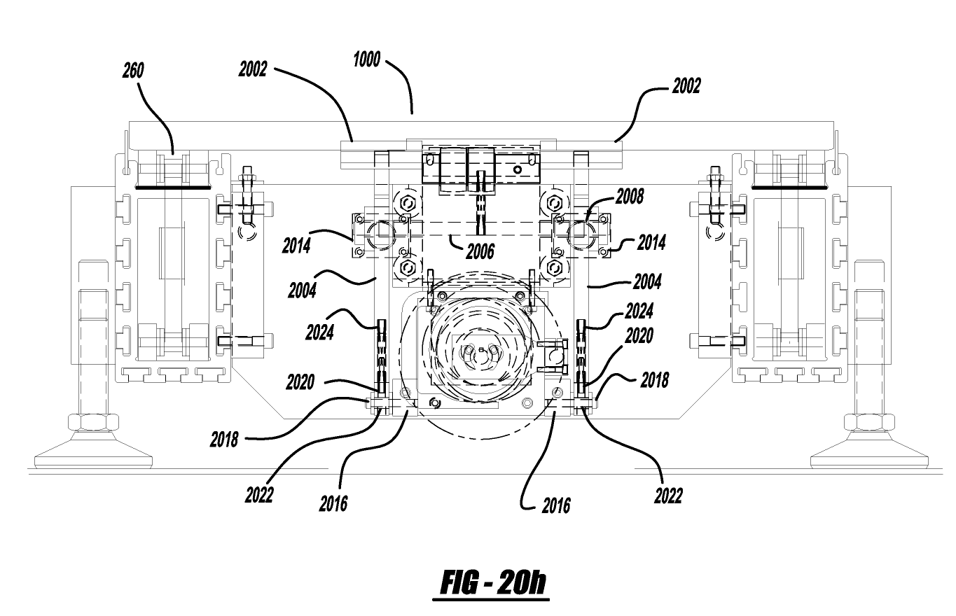

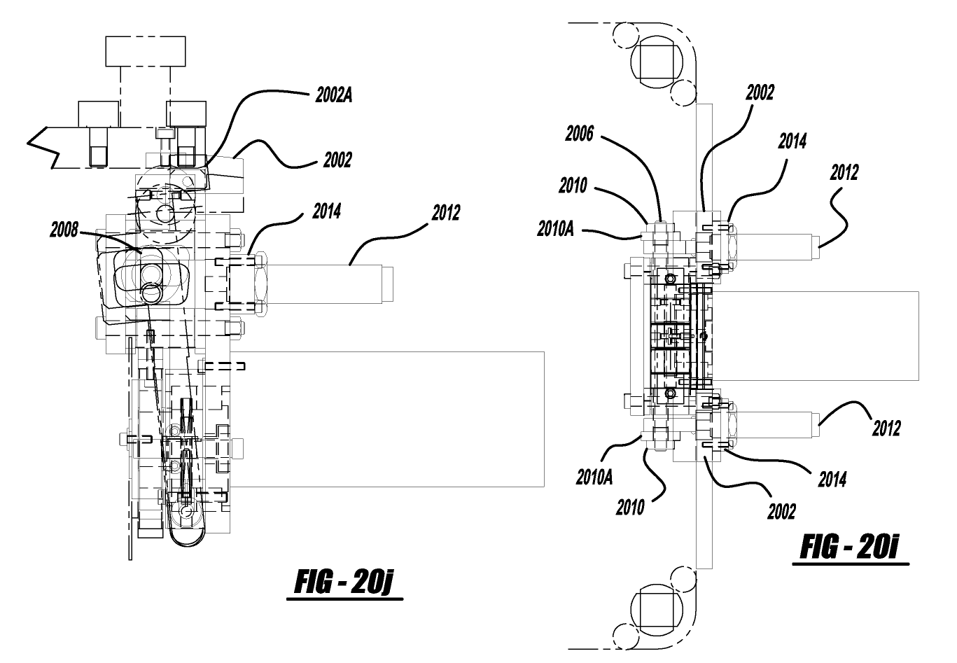

A still other feature of this invention is the pallet enabler 900 of FIGS. 19, 20, and 20a-20j. The pallet enabler 900 stops a pallet 1000 as a result of enabling it to self-lift off the conveyor module chains 260 (e.g., per the two conveyor mounted roller bars 940 each with cam roller 928 and the raised cam roller lift bar 927 with two rollers 928), while it also simultaneously locates itself with precision in the two axis planes X and Z (also the Y axis plane if the four conveyor mounted jack bars 980 are employed). The pallet enabler 900 functions such that it works in cooperation with, and harnesses, the inertial mass of a forward moving pallet 1000, generated by the linear drive friction of the pucks 262 or 262A of the conveyor chain 260.

By way of a non-limiting example, an incoming pallet 1000 first encounters the two conveyor mounted roller bars 940 which each have a cam roller 928 at their top, per an axle pin 941 and two jack screws 942 (e.g., for vertical adjustment), and cross jam set screws 943. The pallet enabler's cam roller lift bar 927 with its two cam rollers 928 (e.g., on axle pin 944, secured with cross-pin 945) is normally always up awaiting the arrival of a pallet 1000 along with an accompanying over-travel dampening bar 929 which is spring loaded up per spring 930 and two position pins 931. The cam roller lift bar 927 only goes down momentarily (e.g., to release a pallet 1000 to continue on to the next work station) per a single revolution of its gear-motor output 921 of its eccentric drive unit 920 (e.g., per its sensor 946, bracket 947, and sensor dog 948), during which time the pallet 1000, as lowered the illustrative 0.04 inches (e.g., minimum approximate distance and/or 0.125 inches maximum approximate distance), contacts the conveyor module chains 260 (e.g., at its front end, i.e., the enabler 900 end) which moves the pallet 1000 forward per its load induced friction, in that the pallet 1000 quickly comes off the conveyor mounted rollers 928 of roller bars 940 (e.g., at its rear end) now making the pallet 1000 fully-flush on both roller chains 260. The pallet 1000 then travels approximately its own full length by the time the cam roller lift bar 927 with its cam rollers 928 are back in their up position, as per a positioning sensor, awaiting the next arrival of a pallet 1000. If the pallet enabler's cam roller lift bar 927 with cam rollers 928 and accompanying over-travel dampening bar 929 (e.g., entrapped between the lift bar 927 and back plate 932) comes up prior to the overhead leaving pallet 1000 clearing it, it is of no consequence as the over-travel dampening bar 929 of the pallet enabler 900 is pushed down per its spring 930 by the exiting pallet 1000 bottom, while the cam roller lift bar 927 with its 928 cam rollers will simply lift the rear of the exiting pallet 1000 (e.g., approximately 0.125 inches maximum) momentarily (e.g., one second maxim estimated), at which point its rear will roll off the rollers 928 of the raised cam roller lift bar 927, then the pallet 1000 quickly clears the over-travel dampening bar 929 (e.g., which will then raise to the up position per the spring 930 and position pins 931, thus ready to dampen the arrival of another pallet 1000).

Upon rolling off the rollers 928 of the raised cam roller lift bar 927 (e.g., before clearing the over-travel dampening bar 929 of the pallet enabler), the pallet 1000 is then again in full contact with the conveyor module chains 260 having never been delayed in its transfer out. A one revolution cycle of the eccentric motion which lifts the lift bar 927 is facilitated by the output shaft of the gear-motor 921, driving an eccentric shaft 924 with its eccentric segment 924A, supported by bearings 923, utilizing eccentric bearing 925 on the eccentric segment 924A, supporting eccentric ring 926, contacting contact rail 926A, with spacer 926B, fastened to lift bar 927. The lift bar 927 is housed fore and aft between two bearing pads 933, spaced by the four bearing roller 935 lengths and eight spacer washers 936, which themselves are housed between the main bracket 922 and front plate 934. Four shoulder screws 937 go through four sandwiched sets of details 934, 936, 935, 936 and 922 and are capped with four nuts 938. The lift bar 927 is housed side to side between the two sets of two bearing rollers 935. The lift bar 927 is comprised of two separate segments 927A and 927B to enable adjustment of side to side vertical running clearance between the lift bar 927 and the four rollers 935 (e.g., anything from a preload to a mild clearance). The two segments 927A and 927B (e.g., which each hold one end each of axle pin 944) are forced apart and set/fixed for desired fit by the two stacked set screws 939 (e.g., one to set desired fit and the other to jam lock in position).

When pallet enabler 900's are properly applied (i.e., positioned) throughout a conveyor system (e.g., facilitating work stations and on-deck stations), the pallet 1000's always stay separated in that they never contact each other throughout the system and they self-stop as previously described in precision X and Z axis positions (and at workstations where desired, with the further addition of simplistic conveyor mounted jack bars 980, precision Y positioning is also attained). The pallet enabler 900 of this invention functions both as the pallet stop and lift-and-locate mechanism. Further, because pallet enablers are also utilized at as many pallet on-deck positions as desired, and spaced so that pallets do not contact each other, there is no need for the pallet bumpers of conventional use. Also, because the pallet 1000 is always off the conveyor chain 260 when in their stopped positions (e.g., as they self-lift off the chains 260), there is no pallet load induced chain drive backpressure, nor is there any pallet load whatsoever applied to the chains in said stopped positions. The pallet enabler 900 of this invention improves chain life from 400% to 500% because the maximum time pallets spend on the chains is approximately 20% (e.g., in a prior art non-synchronous system having two to three on-deck pallets at workstations, pallets spend approximately 80% of their time on the chains, even more if some of the workstations don't lift and locate the pallet).

FIGS. 20h, 20i and 20j are three assorted views of a shock absorber system 2000. The shock absorber system 2000 of the present invention obviates the need for the dampening bar 929, the spring 930, the positioning pins 931 and the back plate 932, e.g., as previously depicted in FIGS. 20c, 20f and 20g. The primary components of the shock absorber system 2000 include impact pads 2002, actuator links 2004, link containment pin 2006, control hole 2008, end caps 2010, end cap washer 2010A, shock absorbers 2012, shock mounting flange 2014, link pivot blocks 2016, link pivot screw 2018, contact spring pin 2020, contact bushings 2022, and springs 2024.

By way of a non-limiting example, an incoming pallet 1000 engages the back vertical ledge 2000A of the impact pads 2002 (e.g., pads are in full up and forward position per extended shocks 2012 that position pads 2002 mounted to actuator links 2004) wherein the up position is dictated by the link containment pin's 2006 bottom contacting the actuator link's 2004 bottom. At the moment of contact, pad's 2002 vertical ledge 2002A and actuator links 2004 are up and forward at link tops (e.g., shocks 2012 push the actuator links 2004 forward while springs 2024 keep actuator links 2004 in the up position). Pallet 1000 impacts pad's 2002 vertical ledge 2002A (e.g., pads are mounted to links) causing the actuator links 2004 to compress shock absorbers 2012 (decelerating the pallet 1000 to a relatively soft stop). All other functions of the pallet enabler 900 are the same except that the actuator links 2004 are spring loaded up by springs 2024 embedded in the actuator links 2004 over contact pins 2020 which contact bushings 2022 which go over pivot screws 2018 which are clamped by link pivot blocks 2016 which are fastened to the main plate 922.

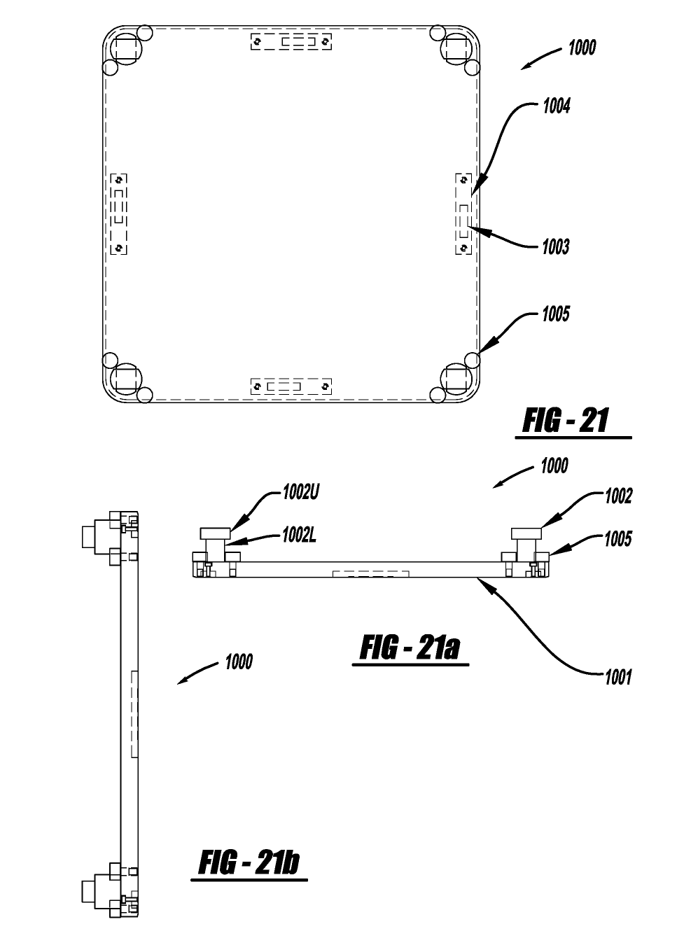

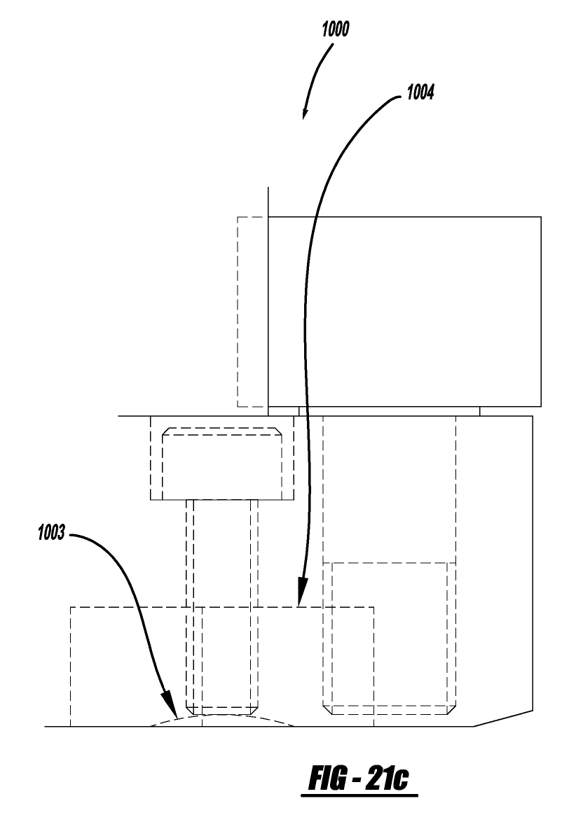

Another feature of this invention is the pallet 1000 (e.g., see FIGS. 21, 21a, 21b and 21c) which reduces capital and maintenance costs by creating a conveyor environment in which lower cost or lighter pallets made of non-hardened steel and other softer but lighter materials such as aluminum can be regularly used. In the improved conveyor transport system of this invention the steel pallet plates can remain soft, negating the need for expensive steels hardened by heat treat or other methods. Further, the pallet plate material can also be “soft” aluminum. This situation is made possible by the non-metallic formulation of the innovative conveyor chain pucks 262, 262A of conveyor modules and pucks 862 of power on/off units integrated into this invention. These relatively soft pucks do not wear the soft steel or aluminum pallet plates as the pallet plate bottoms slide and skid against them during the various pallet transfer functions that occur throughout the system. Simply put, the gravitational friction dynamic between pallet and puck will not result in wear on the pallet that in any way approaches the level of wear engendered by the metal-on-metal contact in conventional systems.

The pallet 1000 can be comprised of a main plate 1001 (e.g., rectangular, square, hexagonal, and/or the like), four irregular shaped corner posts 1002 of a two tier engagement construction to facilitate the conveyor mounted claws 280 and 380 utilized at pallet 1000 rotate and redirection corners throughout a given conveyor system, underside precision location cam follower engagement curvatures 1003 (e.g., one parallel each end face of the pallet) incorporated in replaceable inserts 1004, and eight cam rollers 1005 kitty-corner each irregular shaped corner post 1002 for friction free guidance throughout a given system and to facilitate precision Y axis location at desired stations.

An additional feature of this invention is to provide for the easy construction of even complex pallet transport systems without any variations in elevation whatsoever. Because there are no pallet lift or other pop-up devices anywhere in the system, this invention maintains the same pallet/conveyor height throughout the system no matter how complex the conveyor system configuration. Further, the components of this system allow for a minimum bottom of pallet to floor height of approximately 10.5 inches or 267 mm (e.g., still allowing for an up/down adjustment of approximately 1 inch or 25 mm). The system, of course, can be proportionally sized up or down but to give a perspective to the system components just described the traditional pallets sizes and weights associated would be 24 inches side to side and larger and handle pallets of a thousand pounds and more.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A pallet transport system, comprising:
at least one conveyor module; and
at least one pallet member selectively operable to be disposed on top of and transported by the at least one conveyor module in a first orientation or direction;
wherein the at least one conveyor module is selectively operable to cause the at least one pallet member to travel in a second orientation or direction;
wherein the at least one conveyor module is selectively operable to cause the at least one pallet member to travel in a third orientation or direction;
wherein the at least one pallet member includes at least one post member extending from a peripheral portion of the at least one pallet member;
wherein the at least one conveyor module includes at least one engagement member selectively operable to engage the post member;
wherein when the at least one engagement member selectively engages the at least one post member, the at least one conveyor module is selectively operable to cause the at least one pallet member to be transported in the second orientation or direction;
wherein when the at least one engagement member selectively disengages from the at least one post member, the at least one conveyor module is selectively operable to cause the at least one pallet member to be transported in the third orientation or direction.

2. The invention according to claim 1, wherein the at least one conveyor module includes a chain system, wherein the chain system includes a plurality of cooperating link pin members and roller members, wherein a first puck member is disposed on at least one of the link pin members.

3. The invention according to claim 2, wherein the first puck member includes an area defining a first through bore, wherein a first end portion of the link pin member is selectively operable to be received in the first through bore.

4. The invention according to claim 2, wherein the first puck member has a substantially rectangular configuration.

5. The invention according to claim 2, wherein the first puck member includes a beveled surface portion.

6. The invention according to claim 2, further comprising a second puck member including an area defining a second through bore, wherein a second end portion of the link pin member is selectively operable to be received in the second through bore, wherein when the first and second ends of the link pin member are received in the first and second through bores, the chain system is substantially enveloped between the first and second puck members.

7. The invention according to claim 1, wherein the at least one conveyor module includes a chain system, wherein the chain system includes a plurality of cooperating link pin members and roller members, wherein a first puck member is disposed in between two adjacent link pin members.

8. The invention according to claim 7, wherein the first puck member has a substantially rectangular configuration.

9. The invention according to claim 7, wherein the first puck member includes a beveled surface portion.

10. The invention according to claim 7, wherein the first puck member includes a first groove portion formed on at least one surface portion thereof, wherein a first link pin member is selectively operable to be at least partially received in the first groove portion.

11. The invention according to claim 7, further comprising a second puck member including a second groove portion formed on at least one surface thereof, wherein a second link pin member is selectively operable to be at least partially received in the second groove portion, wherein when the first and second link pin members are at least partially received in the first and second groove portions, the chain system is substantially enveloped between the first and second puck members.

12. The invention according to claim 2, further comprising a flush adjustment system operably associated with the chain system, wherein the flush adjustment system is selectively operable to vertically pivotally adjust at least a portion of the chain system.

13. The invention according to claim 2, wherein the chain system comprises a dual beam system including a first chain member having a first length and a second chain member having a second length.

14. The invention according to claim 13, wherein the first length is not equal to the second length.

15. The invention according to claim 2, further comprising a motorized drive system operably associated with the chain system, wherein the motorized drive system is selectively operable to cause locomotion of the chain system.

16. The invention according to claim 1, further comprising a plurality of post members and engagement members.

17. The invention according to claim 1, wherein the second orientation or direction comprises a radially sweeping motion by the pallet member.

18. The invention according to claim 1, wherein the first orientation or direction and the third orientation or direction are dissimilar.

19. The invention according to claim 1, wherein the at least one conveyor module is selectively operable to rotate the at least one pallet member in a clockwise or counterclockwise direction.

20. The invention according to claim 1, wherein the at least one conveyor module includes a support roller system for supporting the at least one pallet member as the at least one pallet member attempts to travel onto another conveyor module.

21. The invention according to claim 1, further comprising a pallet enabler system operably associated with the at least one conveyor module, wherein the pallet enabler system is selectively operable to disengage the at least one pallet member from the at least one conveyor module so as to cause the locomotion of the at least one pallet member to cease.

22. The invention according to claim 1, wherein the at least one conveyor module includes a chain system, wherein the chain system includes a plurality of cooperating link pin members and roller members, and further comprises a pass through lateral transfer system operatively associated with the chain system for transporting the at least one pallet member in a direction angled with respect to the chain system.

23. The invention according to claim 22, wherein the pass through lateral transfer system includes a second chain system, wherein the second chain system is angled with respect to the chain system.

24. The invention according to claim 23, wherein the second chain system includes a third puck member, wherein the second chain system includes an area free of any of the third puck members, wherein the third puck member permits the angled transportation of the at least one pallet member, wherein the area free of any of the third puck members permits the transportation of the at least one pallet member along the chain system.

25. A pallet transport system, comprising:
a first conveyor module;
a second conveyor module operatively associated with the first conveyor module; and
at least one pallet member selectively operable to be disposed on top of and transported by the first conveyor modules in a first orientation or direction;
wherein the at least one pallet member includes at least one post member extending from a peripheral portion of the at least one pallet member;
wherein the first conveyor module includes at least one engagement member selectively operable to engage the at least one post member;
wherein when the at least one engagement member selectively engages the at least one post member, the at least one conveyor module is selectively operable to cause the at least one pallet member to be transported in a second orientation or direction;
wherein when the at least one engagement member selectively disengages from the at least one post member, the first conveyor module is selectively operable to cause the at least one pallet member to be disposed on top of and transported by the second conveyor module in a third orientation or direction.

26. The invention according to claim 25, wherein either the first or second conveyor modules includes a chain system, wherein the chain system includes a plurality of cooperating link pin members and roller members, wherein a first puck member is disposed on at least one of the link pin members.

27. The invention according to claim 26, wherein the first puck member includes an area defining a first through bore, wherein a first end portion of the link pin member is selectively operable to be received in the first through bore.

28. The invention according to claim 26, wherein the first puck member has a substantially rectangular configuration.

29. The invention according to claim 26, wherein the first puck member includes a beveled surface portion.

30. The invention according to claim 26, further comprising a second puck member including an area defining a second through bore, wherein a second end portion of the link pin member is selectively operable to be received in the second through bore, wherein when the first and second ends of the link pin member are received in the first and second through bores, the chain system is substantially enveloped between the first and second puck members.

31. The invention according to claim 25, wherein either of the first or second conveyor modules include a chain system, wherein the chain system includes a plurality of cooperating link pin members and roller members, wherein a first puck member is disposed in between two adjacent link pin members.

32. The invention according to claim 31, wherein the first puck member has a substantially rectangular configuration.

33. The invention according to claim 31, wherein the first puck member includes a beveled surface portion.

34. The invention according to claim 31, wherein the first puck member includes a first groove portion formed on at least one surface portion thereof, wherein a first link pin member is selectively operable to be at least partially received in the first groove portion.

35. The invention according to claim 31, further comprising a second puck member including a second groove portion formed on at least one surface thereof, wherein a second link pin member is selectively operable to be at least partially received in the second groove portion, wherein when the first and second link pin members are at least partially received in the first and second groove portions, the chain system is substantially enveloped between the first and second puck members.

36. The invention according to claim 26, further comprising a flush adjustment system operably associated with the chain system, wherein the flush adjustment system is selectively operable to vertically pivotally adjust at least a portion of the chain system.

37. The invention according to claim 26, wherein the chain system comprises a dual beam system including a first chain member having a first length and a second chain member having a second length.

38. The invention according to claim 37, wherein the first length is not equal to the second length.

39. The invention according to claim 26, further comprising a motorized drive system operably associated with the chain system, wherein the motorized drive system is selectively operable to cause locomotion of the chain system.

40. The invention according to claim 25, further comprising a plurality of post members and engagement members.

41. The invention according to claim 25, wherein the second orientation or direction comprises a radially sweeping motion by the pallet member.

42. The invention according to claim 25, wherein the first orientation or direction and the third orientation or direction are dissimilar.

43. The invention according to claim 25, wherein either of the first or second conveyor modules are selectively operable to rotate the at least one pallet member in a clockwise or counterclockwise direction.

44. The invention according to claim 25, wherein either of the first or second conveyor modules include a support roller system for supporting the at least one pallet member as the at least one pallet member attempts to travel on either the first or second conveyor modules.

45. The invention according to claim 25, further comprising a pallet enabler system operably associated with either of the first or second conveyor modules, wherein the pallet enabler system is selectively operable to disengage the at least one pallet member from either the first or second conveyor modules so as to cause the locomotion of the at least one pallet member to cease.

46. The invention according to claim 25, wherein either the first or second conveyor modules include a chain system, wherein the chain system includes a plurality of cooperating link pin members and roller members, and further comprises a pass through lateral transfer system operatively associated with the chain system for transporting the at least one pallet member in a direction angled with respect to the chain system.

47. The invention according to claim 46, wherein the pass through lateral transfer system includes a second chain system, wherein the second chain system is angled with respect to the chain system.

48. The invention according to claim 47, wherein the second chain system includes a third puck member, wherein the second chain system includes an area free of any of the third puck members, wherein the third puck member permits the angled transportation of the at least one pallet member, wherein the area free of any of the third puck members permits the transportation of the at least one pallet member along the chain system.

49. A pallet transport system, comprising:
a first conveyor module;
a second conveyor module operatively associated with the first conveyor module;
a third conveyor module operatively associated with the second conveyor module;
a fourth conveyor module operatively associated with the third conveyor module; and
at least one pallet member selectively operable to be disposed on top of and transported by the first conveyor module in a first orientation or direction;
wherein the at least one pallet member includes at least one post member extending from a peripheral portion of the at least one pallet member;
wherein the first conveyor module includes at least one engagement member selectively operable to engage the at least one post member;
wherein when the at least one engagement member selectively engages the at least one post member, the at least one conveyor module is selectively operable to cause the at least one pallet member to be transported in a second orientation or direction;
wherein when the at least one engagement member selectively disengages from the at least one post member, the first conveyor module is selectively operable to cause the at least one pallet member to be disposed on top of and transported by any of the second, third or fourth conveyor modules in a third orientation or direction.

50. The invention according to claim 49, wherein any of the conveyor modules includes a chain system, wherein the chain system includes a plurality of cooperating link pin members and roller members, wherein a first puck member is disposed on at least one of the link pin members.

51. The invention according to claim 50, wherein the first puck member includes an area defining a first through bore, wherein a first end portion of the link pin member is selectively operable to be received in the first through bore.

52. The invention according to claim 50, wherein the first puck member has a substantially rectangular configuration.

53. The invention according to claim 50, wherein the first puck member includes a beveled surface portion.

54. The invention according to claim 50, further comprising a second puck member including an area defining a second through bore, wherein a second end portion of the link pin member is selectively operable to be received in the second through bore, wherein when the first and second ends of the link pin member are received in the first and second through bores, the chain system is substantially enveloped between the first and second puck members.

55. The invention according to claim 49, wherein any of the conveyor modules include a chain system, wherein the chain system includes a plurality of cooperating link pin members and roller members, wherein a first puck member is disposed in between two adjacent link pin members.

56. The invention according to claim 55, wherein the first puck member has a substantially rectangular configuration.

57. The invention according to claim 55, wherein the first puck member includes a beveled surface portion.

58. The invention according to claim 55, wherein the first puck member includes a first groove portion formed on at least one surface portion thereof, wherein a first link pin member is selectively operable to be at least partially received in the first groove portion.

59. The invention according to claim 55, further comprising a second puck member including a second groove portion formed on at least one surface thereof, wherein a second link pin member is selectively operable to be at least partially received in the second groove portion, wherein when the first and second link pin members are at least partially received in the first and second groove portions, the chain system is substantially enveloped between the first and second puck members.

60. The invention according to claim 50, further comprising a flush adjustment system operably associated with the chain system, wherein the flush adjustment system is selectively operable to vertically pivotally adjust at least a portion of the chain system.

61. The invention according to claim 50, wherein the chain system comprises a dual beam system including a first chain member having a first length and a second chain member having a second length.

62. The invention according to claim 61, wherein the first length is not equal to the second length.

63. The invention according to claim 50, further comprising a motorized drive system operably associated with the chain system, wherein the motorized drive system is selectively operable to cause locomotion of the chain system.

64. The invention according to claim 49, further comprising a plurality of post members and engagement members.

65. The invention according to claim 49, wherein the second orientation or direction comprises a radially sweeping motion by the pallet member.

66. The invention according to claim 49, wherein the first orientation or direction and the third orientation or direction are dissimilar.

67. The invention according to claim 49, wherein any of the conveyor modules are selectively operable to rotate the at least one pallet member in a clockwise or counterclockwise direction.

68. The invention according to claim 49, wherein any of the conveyor modules include a support roller system for supporting the at least one pallet member as the at least one pallet member attempts to travel on any of the conveyor modules.

69. The invention according to claim 49, further comprising a pallet enabler system operably associated with any of the conveyor modules, wherein the pallet enabler system is selectively operable to disengage the at least one pallet member from any of the conveyor modules so as to cause the locomotion of the at least one pallet member to cease.

70. The invention according to claim 49, wherein any of the first, second, third or fourth conveyor modules include a chain system, wherein the chain system includes a plurality of cooperating link pin members and roller members, and further comprises a pass through lateral transfer system operatively associated with the chain system for transporting the at least one pallet member in a direction angled with respect to the chain system.

71. The invention according to claim 70, wherein the pass through lateral transfer system includes a second chain system, wherein the second chain system is angled with respect to the chain system.

72. The invention according to claim 71, wherein the second chain system includes a third puck member, wherein the second chain system includes an area free of any of the third puck members, wherein the third puck member permits the angled transportation of the at least one pallet member, wherein the area free of any of the third puck members permits the transportation of the at least one pallet member along the chain system.

73. A pallet transport system, comprising:
a first conveyor module;
a second conveyor module operably associated with the first conveyor module; and
at least one pallet member selectively operable to be disposed on top of and transported by either of the first or second conveyor modules;
wherein the first conveyor module is selectively operable to cause the at least one pallet member to travel in a first orientation or direction;
wherein the second conveyor module is selectively operable to cause the at least one pallet member to travel in a second orientation or direction.

74. The invention according to claim 73, wherein the at least one pallet member includes at least one post member extending from a peripheral portion of the at least one pallet member, wherein the at least one conveyor module includes at least one engagement member selectively operable to engage the post member, wherein when the at least one engagement member selectively engages the at least one post member, the first conveyor module is selectively operable to cause the at least one pallet member to execute a radially sweeping motion, wherein when the at least one engagement member selectively disengages from the at least one post member, the first conveyor module is selectively operable to cause the at least one pallet member to be transported in a substantially linear motion.

75. The invention according to claim 73, wherein either of the first or second conveyor modules include a chain system, wherein the chain system includes a plurality of cooperating link pin members and roller members, wherein a first puck member is disposed on at least one of the link pin members.

76. The invention according to claim 75, wherein the first puck member includes an area defining a first through bore, wherein a first end portion of the link pin member is selectively operable to be received in the first through bore.

77. The invention according to claim 75, wherein the first puck member has a substantially rectangular configuration.

78. The invention according to claim 75, wherein the first puck member includes a beveled surface portion.

79. The invention according to claim 75, further comprising a second puck member including an area defining a second through bore, wherein a second end portion of the link pin member is selectively operable to be received in the second through bore, wherein when the first and second ends of the link pin member are received in the first and second through bores, the chain system is substantially enveloped between the first and second puck members.

80. The invention according to claim 73, wherein either of the first or second conveyor modules include a chain system, wherein the chain system includes a plurality of cooperating link pin members and roller members, wherein a first puck member is disposed in between two adjacent link pin members.

81. The invention according to claim 80, wherein the first puck member has a substantially rectangular configuration.

82. The invention according to claim 80, wherein the first puck member includes a beveled surface portion.

83. The invention according to claim 80, wherein the first puck member includes a first groove portion formed on at least one surface portion thereof, wherein a first link pin member is selectively operable to be at least partially received in the first groove portion.

84. The invention according to claim 80, further comprising a second puck member including a second groove portion formed on at least one surface thereof, wherein a second link pin member is selectively operable to be at least partially received in the second groove portion, wherein when the first and second link pin members are at least partially received in the first and second groove portions, the chain system is substantially enveloped between the first and second puck members.

85. The invention according to claim 75, further comprising a flush adjustment system operably associated with the chain system, wherein the flush adjustment system is selectively operable to vertically pivotally adjust at least a portion of the chain system.

86. The invention according to claim 75, wherein the chain system comprises a dual beam system including a first chain member having a first length and a second chain member having a second length.

87. The invention according to claim 86, wherein the first length is not equal to the second length.

88. The invention according to claim 75, further comprising a motorized drive system operably associated with the chain system, wherein the motorized drive system is selectively operable to cause locomotion of the chain system.

89. The invention according to claim 73, further comprising a plurality of post members and engagement members.

90. The invention according to claim 73, wherein the first orientation or direction and the second orientation or direction are dissimilar.

91. The invention according to claim 73, wherein either of the first or second conveyor modules are selectively operable to rotate the at least one pallet member in a clockwise or counterclockwise direction.

92. The invention according to claim 73, wherein either of the first or second conveyor modules include a support roller system for supporting the at least one pallet member as the at least one pallet member attempts to travel onto either of the first or second conveyor modules.

93. The invention according to claim 73, further comprising a pallet enabler system operably associated with either of first or second conveyor modules, wherein the pallet enabler system is selectively operable to disengage the at least one pallet member from either of the first or second conveyor modules so as to cause the locomotion of the at least one pallet member to cease.

94. The invention according to claim 73, wherein either the first or second conveyor modules include a chain system, wherein the chain system includes a plurality of cooperating link pin members and roller members, and further comprises a pass through lateral transfer system operatively associated with the chain system for transporting the at least one pallet member in a direction angled with respect to the chain system.

95. The invention according to claim 94, wherein the pass through lateral transfer system includes a second chain system, wherein the second chain system is angled with respect to the chain system.

96. The invention according to claim 95, wherein the second chain system includes a third puck member, wherein the second chain system includes an area free of any of the third puck members, wherein the third puck member permits the angled transportation of the at least one pallet member, wherein the area free of any of the third puck members permits the transportation of the at least one pallet member along the chain system.
